(19) United States
(12) Patent Application Publication
(10) Pub. No.: US 2026/0230286 A1
(43) Pub. Date: Aug. 6, 2026

(54) TRANSMISSION CONFIGURATION INDICATOR STATE POOL

(71) Applicant: Lenovo (Beijing) Limited, Beijing (CN)

(72) Inventors: Shuigen Yang, Shanghai (CN); Bingchao Liu, Beijing (CN); Mingzeng Dai, Shanghai (CN); Lianhai Wu, Beijing (CN)

(73) Assignee: Lenovo (Beijing) Limited, Beijing (CN)

(21) Appl. No.: 19/151,931

(22) PCT Filed: Jun. 26, 2023
(86) PCT No.: PCT/CN2023/102470

§ 371 Date: Jul. 29, 2025

(51) Int. Cl. H04L 5/00

(52) U.S. Cl. CPC H04L 5/0091

(57) ABSTRACT

Various aspects of the present disclosure relate to a base station, a user equipment, a method and an apparatus for determining a transmission configuration indicator state pool. The base station may include a processor; and a transceiver coupled to the processor, wherein the processor is configured to determine a plurality of TCI states for a candidate cell, wherein each TCI state of the plurality of TCI states is associated with the candidate cell or other candidate cells or a serving cell; and transmit a TCI state pool to a UE, wherein the TCI state pool provides a mapping of each TCI state to the associated candidate cell or the other candidate cells or the serving cell. By implementing the embodiments of the present disclosure, the index conflict or index confusion among different DUs can be avoided, and the UE can have a common understanding of the TCI state indexes.

### TECHNICAL FIELD

The present disclosure relates to wireless communications, and more specifically to a base station, a user equipment, a method and an apparatus for determining a transmission configuration indicator (TCI) state pool.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A next-generation node B (gNB) configured for operation in a fifth-generation system (5GS) encode signaling for transmission to a UE indicating a transmission configuration indicator (TCI) state change to activate a new TCI state. A physical downlink control channel (PDCCH) is encoded in accordance with a highest aggregation level if the signaling indicating the TCI state change indicates activation of a new TCI state for the PDCCH. A physical downlink shared channel (PDSCH) is encoded in accordance with a lowest modulation and coding scheme (MCS) level if the signaling indicating the TCI state change indicates activation of a new TCI state for the PDSCH. After the TCI state change, reference signals (RS) are transmitted with a different spatial filter or different antenna ports demodulation of the PDCCH and PDSCH by the UE.

### SUMMARY

The present disclosure relates to a base station, a UE, a method and an apparatus for determining a transmission configuration indicator state pool.

Some implementations of the base station described herein may include a processor; and a transceiver coupled to the processor, wherein the processor is configured to determine a plurality of TCI states for a candidate cell, wherein each TCI state of the plurality of TCI states is associated with the candidate cell or other candidate cells or a serving cell; and transmit, via the transceiver, a TCI state pool to a UE, wherein the TCI state pool provides a mapping of each TCI state to the associated candidate cell or the other candidate cells or the serving cell.

Some implementations of the UE described herein may include a processor; and a transceiver coupled to the processor, wherein the processor is configured to receive, via the transceiver, a TCI state pool from a base station, wherein each TCI state of a plurality of TCI states for a candidate cell is associated with the candidate cell or other candidate cells or a serving cell, wherein the TCI state pool provides a mapping of each TCI state to the associated candidate cell or the other candidate cells or the serving cell.

Some implementations of the method described herein may include determining a plurality of TCI states for a candidate cell, wherein each TCI state of the plurality of TCI states is associated with the candidate cell or other candidate cells or a serving cell; and transmitting a TCI state pool to a UE, wherein the TCI state pool provides a mapping of each TCI state to the associated candidate cell or the other candidate cells or the serving cell.

Some implementations of the apparatus described herein may include at least one memory; and at least one processor coupled with the at least one memory and configured to cause the apparatus to: receive a transmission configuration indicator (TCI) state pool from a base station, wherein each TCI state of a plurality of TCI states for a candidate cell is associated with the candidate cell or other candidate cells or a serving cell, wherein the TCI state pool provides a mapping of each TCI state to the associated candidate cell or the other candidate cells or the serving cell.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

FIG. 1A illustrates an example of a wireless communications system that supports determining a TCI state pool in accordance with aspects of the present disclosure.

FIGS. 1B to 1D illustrate examples of scenarios of layer 1 (L1)/layer 2 (L2) triggered mobility (LTM) related to aspects of the present disclosure.

FIGS. 1E and 1F illustrate examples of TCI state pools for LTM related to aspects of the present disclosure.

FIG. 2 illustrates an example signalling procedure for determining a TCI state pool in accordance with aspects of the present disclosure.

FIG. 3 illustrates an example signalling procedure for determining a TCI state pool where the TCI state pool for a serving cell and the TCI state pool for a candidate cell is generated separately in accordance with aspects of the present disclosure.

FIG. 4 illustrates an example group ID of TCI states to be activated in accordance with aspects of the present disclosure.

FIG. 5 illustrates an example signalling procedure for determining a TCI state pool where the TCI state pool for a serving cell and the TCI state pool for a candidate cell is generated by the CU in accordance with aspects of the present disclosure.

FIG. 6 illustrates an example signalling procedure for determining a TCI state pool where the TCI state pool for a serving cell and the TCI state pool for a candidate cell is generated by the DU in accordance with aspects of the present disclosure.

FIG. 7 illustrates an example signalling procedure for determining a TCI state pool where new TCI state indexes are used in accordance with aspects of the present disclosure.

FIG. 8 illustrates an example signalling procedure for determining a TCI state pool where the TCI state pool for a serving cell and the TCI state pool for a candidate cell are organized independently in accordance with aspects of the present disclosure.

FIG. 9 illustrates an example command to activate TCI states in accordance with aspects of the present disclosure.

FIGS. 10 and 11 illustrate examples of devices that support determining a TCI state pool in accordance with aspects of the present disclosure.

FIGS. 12 and 13 illustrate examples of processors that support determining a TCI state pool in accordance with aspects of the present disclosure.

FIGS. 14 and 15 illustrate flowcharts of methods that support determining a TCI state pool in accordance with aspects of the present disclosure.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, 5G NR, long term evolution (LTE), LTE-advanced (LTE-A), wideband code division multiple access (WCDMA), high-speed packet access (HSPA), narrow band internet of things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a remote radio unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VOIP) phone, a wireless local loop phone, a tablet, a wearable terminal device, a personal digital assistant (PDA), a portable computer, a desktop computer, an image capture terminal device such as a digital camera, a gaming terminal device, a music storage and playback appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an internet of things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

For the final TCI state pool, the TCI state pool for a serving cell includes the TCI states associated with the serving cell and/or candidate cell(s). The TCI state pool for the candidate cell includes the TCI states associated with the candidate cell and/or other candidate cells. The TCI states associated with each cell (serving cell or candidate cell) are provided by the cell itself. However, each TCI state is associated with a unique index (e.g., TCI state ID) which is used to identity one TCI state configuration, how does the TCI state index is generated to avoid the index conflict or index confusion among different distributed units (DUs) (such as source DU or candidate DU) and how do the DU and the UE have common understanding of the TCI state indexes are issues to be solved.

Therefore, the present disclosure proposed a solution for determining a TCI pool. In this solution, the TCI state index in the final TCI state pool for the serving cell and the TCI state index in the final TCI state pool for the candidate cell are generated by at least one of central unit (CU) or DU in the base station.

By implementing the example embodiments of the present disclosure, the index conflict or index confusion among different DUs (source DU or candidate DU) can be avoided, and the UE can have a common understanding of the TCI state indexes.

Aspects of the present disclosure are described in the context of a wireless communications system.

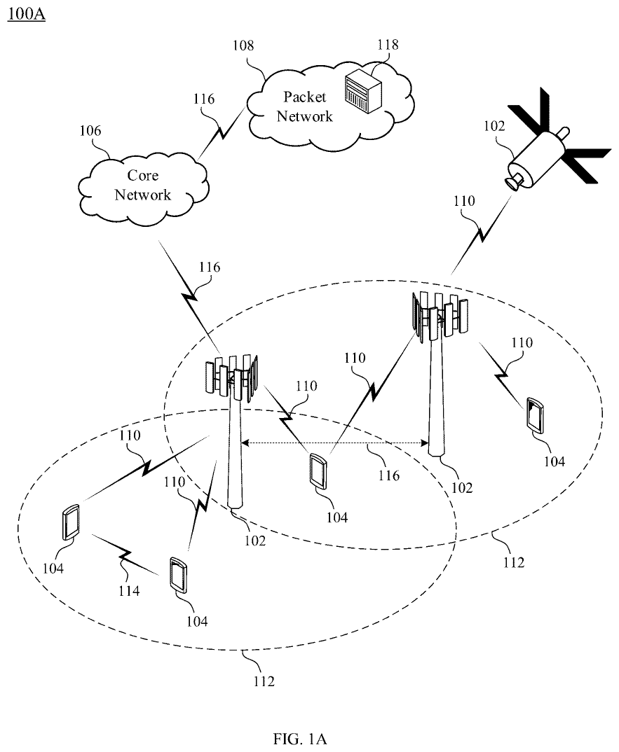

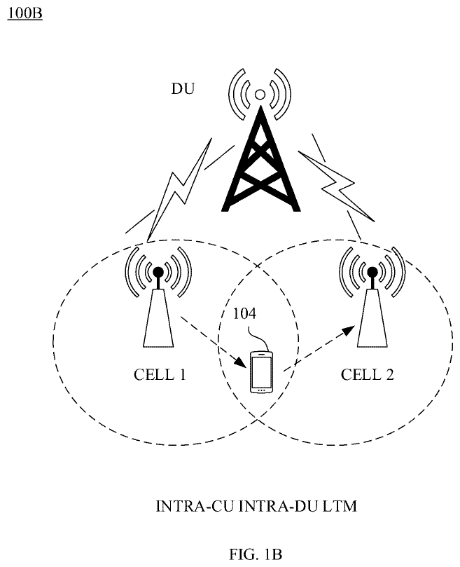

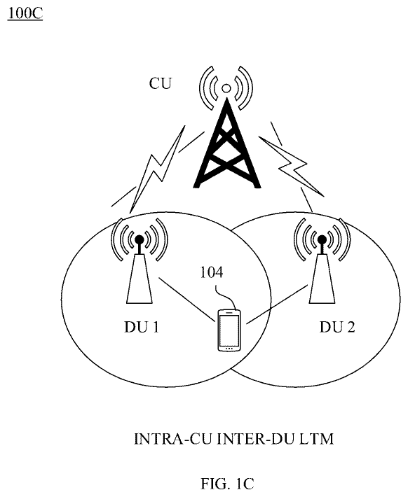

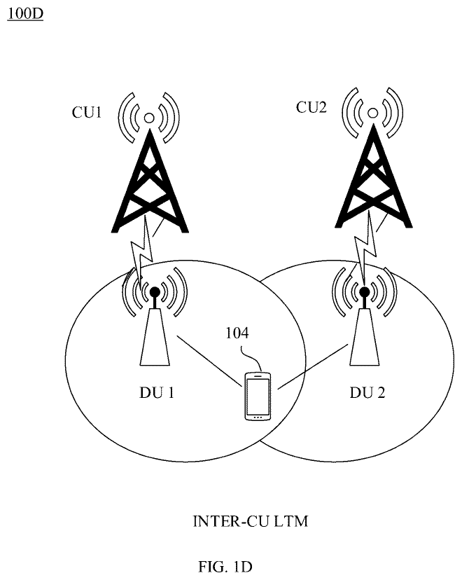

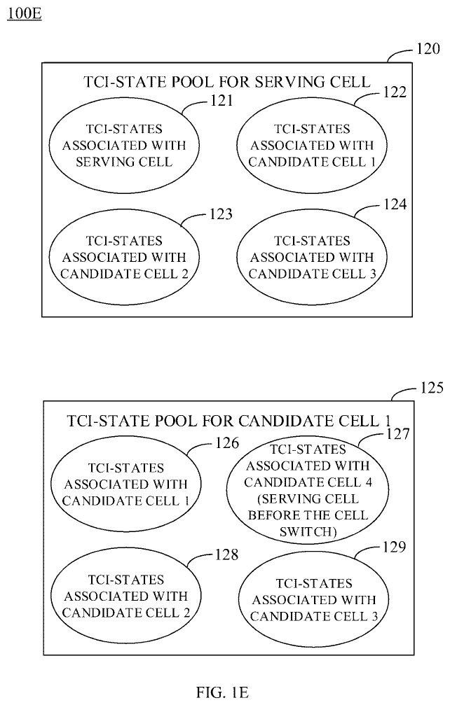

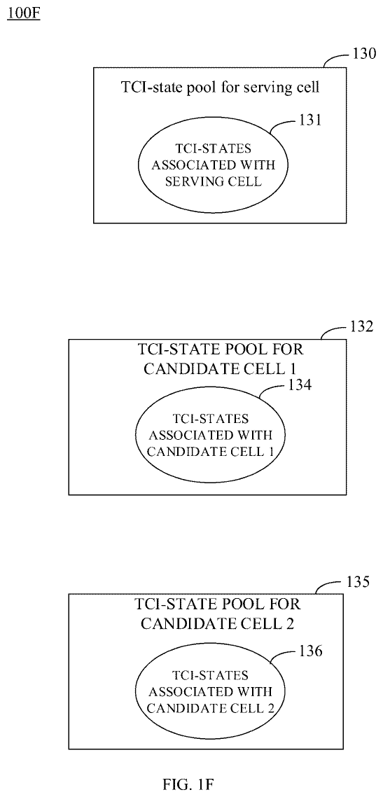

FIG. 1A illustrates an example of a wireless communications system 100A that supports determining a TCI pool in accordance with aspects of the present disclosure. The wireless communications system 100A may include one or more network entities 102 (also referred to as network equipment (NE)), one or more UEs 104, a core network 106, and a packet data network 108. The wireless communications system 100 may support various radio access technologies. In some implementations, the wireless communications system 100 may be a 4G network, such as an LTE network or an LTE-advanced (LTE-A) network. In some other implementations, the wireless communications system 100 may be a 5G network, such as an NR network. In other implementations, the wireless communications system 100 may be a combination of a 4G network and a 5G network, or other suitable radio access technology including institute of electrical and electronics engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an internet-of-things (IoT) device, an internet-of-everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1A. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1A. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open radio access network (O-RAN) (e.g., a network configuration sponsored by the O-RAN Alliance), or a virtualized RAN (vRAN) (e.g., a cloud RAN (C-RAN)). For example, a network entity 102 may include one or more of a CU, a DU, a radio unit (RU), a RAN intelligent controller (RIC) (e.g., a near-real time RIC (Near-RT RIC), a non-real time RIC (Non-RT RIC)), a service management and orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), packet data convergence protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

When a UE moves from one cell to another cell, at some point a serving cell change needs to be performed. In the legacy, the serving cell change is done by explicit radio resource control (RRC) reconfiguration signalling to trigger the synchronization of target cell based on L3 measurements report. It leads to longer latency, larger overhead, and longer interruption time than beam level mobility. Therefore, in 3GPP, a new work item on further new radio (NR) mobility enhancements, named as LTM, was approved to enable a serving cell change via L1/L2 signalling, in order to reduce the latency, overhead and interruption time. The potential applicable scenarios of LTM may include intra-CU intra-DU mobility, intra-CU inter-DU mobility, and inter-CU mobility.

FIG. 1B illustrates an example of a scenario of intra-CU intra-DU LTM mobility 100B related to aspects of the present disclosure. In the intra-CU intra-DU mobility, the UE 104 moves between different cells within a DU. In short, this scenario is called as intra-DU LTM.

FIG. 1C illustrates an example of a scenario of intra-CU inter-DU LTM mobility 100C related to aspects of the present disclosure. In the intra-CU inter-DU mobility, the UE 104 moves between different cells belonging to different DUs but within a CU. In short, this scenario is called as inter-DU LTM.

FIG. 1D illustrates an example of a scenario of inter-CU mobility 100D related to aspects of the present disclosure. In the inter-CU mobility, the UE 104 moves between different cells belonging to different DUs, where the DUs belongs to different CUs. In short, this scenario is called as inter-CU LTM.

In the radio network, the UE can be configured with a list of up to 128 TCI state configurations to decode PDSCH according to a detected PDCCH with downlink control information (DCI) intended for the UE and the given serving cell. Each TCI state contains parameters for configuring a quasi co-location (QCL) relationship between one or two downlink reference signals and the DM-RS ports of the PDSCH, the demodulation reference signals (DM-RS) port of PDCCH or the channel state information (CSI)-RS port(s) of a CSI-RS resource. The quasi co-location types corresponding to each downlink (DL) RS may take one of the following values (1)-(4).

Value (1) may be that ‘typeA’: {Doppler shift, Doppler spread, average delay, delay spread}. Value (2) may be that ‘typeB’: {Doppler shift, Doppler spread}. Value (3) may be that ‘typeC’: {Doppler shift, average delay}. Value (4) may be that ‘typeD’: {Spatial Rx parameter}.

There are two potential alternatives of TCI state pool for LTM. They will be discussed with reference to FIGS. 1E and 1F. FIG. 1E illustrates an example of a mixed TCI state pool 100E related to aspects of the present disclosure. As shown in FIG. 1E, the mixed TCI state pool 100E may include the TCI state pool 120 for a serving cell, which may include the TCI states 121 associated with the serving cell, the TCI states 122 associated with candidate cell 1, the TCI states 123 associated with candidate cell 2, and the TCI states 124 associated with candidate cell 3, etc.

The mixed TCI state pool 100E may include the TCI state pool 125 for candidate cell 1, which may include the TCI states 126 associated with candidate cell 1, the TCI states 128 associated with candidate cell 2, and the TCI states 129 associated with candidate cell 3, and TCI states 127 associated with candidate cell 4, etc. In this disclosure, the TCI states associated with candidate cell/serving cell means that the TCI states configured in the candidate cell/serving cell, e.g., the TCI states of the candidate cell/serving cell.

FIG. 1F illustrates an example of an independent TCI state pool 100F related to aspects of the present disclosure. As shown in FIG. 1F, the independent TCI state pool 100F may include TCI states for a serving cell, and TCI states for candidate cells. Each candidate cell has its own TCI state. The TCI state pool for the serving cell and the TCI state pool for the candidate cell are organized independently. For example, the TCI state pool 130 for the serving cell may include the TCI states 131 associated with serving cell, the TCI state pool 132 for candidate cell 1 may include the TCI states 134 associated with candidate cell 1, and the TCI state pool 135 for candidate cell 2 may include the TCI states 136 associated with candidate cell 2.

Considering the different organizations of TCI state pool for LTM, to support the TCI state activation, the following issues (1) to (4) may be considered. For the mixed TCI state pool, the TCI state pool for serving cell includes the TCI states associated with serving cell and candidate cell(s), and the TCI state pool for candidate cell includes the TCI states associated with the candidate cell and other candidate cells. The TCI states associated with each cell (serving cell or candidate cell) are provided by the cell itself. However, in the mixed TCI state pool, each TCI state is associated with a unique index (e.g., TCI stateId) which is used to identity one TCI state configuration, how does the TCI state index is generated to avoid the index conflict or index confusion among different DUs (source DU or candidate DU) and how do the DU and the UE have common understanding of the TCI state indexes are issue (1).

Issue (2) may be that the initial TCI state is provided the candidate DU. If the candidate DU provides the TCI states associated with each candidate cell without limited number, the TCI states in the final TCI state pool for the UE will be too complex and the signalling overhead will be too large. For example, following the legacy TCI state framework, the maximum number of TCI states per cell is 128. Considering the LTM, if there are 8 candidate cells, the final number of TCI state for the UE will be 1024.

Issue (3) may be that for the independent TCI state pool, the TCI state pool for serving cell and the TCI state pool for candidate cell are organized independently. How to support the subsequent LTM, e.g., the LTM cell switch is supported without RRC reconfiguration after the UE connects to the candidate cell.

Furthermore, how to support TCI state activation associated with multiple candidate cells using the same activation command may be issue (4).

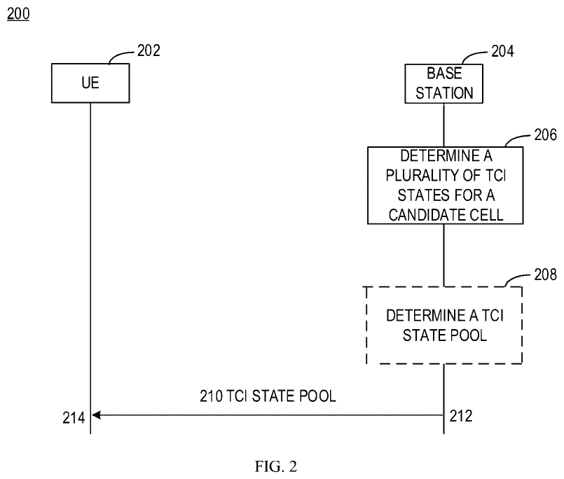

In view of the above, the present disclosure proposed a solution for determining a TCI state pool. FIG. 2 illustrates an example signalling procedure 200 for determining a TCI state pool in accordance with aspects of the present disclosure.

As shown in FIG. 2, a UE 202 may correspond to the UE 104 in FIG. 1A and a base station 204 may correspond to the network entity 102 in FIG. 1A. At 206, the base station 204 determines a plurality of TCI states for a candidate cell. Each TCI state of the plurality of TCI states is associated with the candidate cell, or is associated with other candidate cells, or is associated with a serving cell.

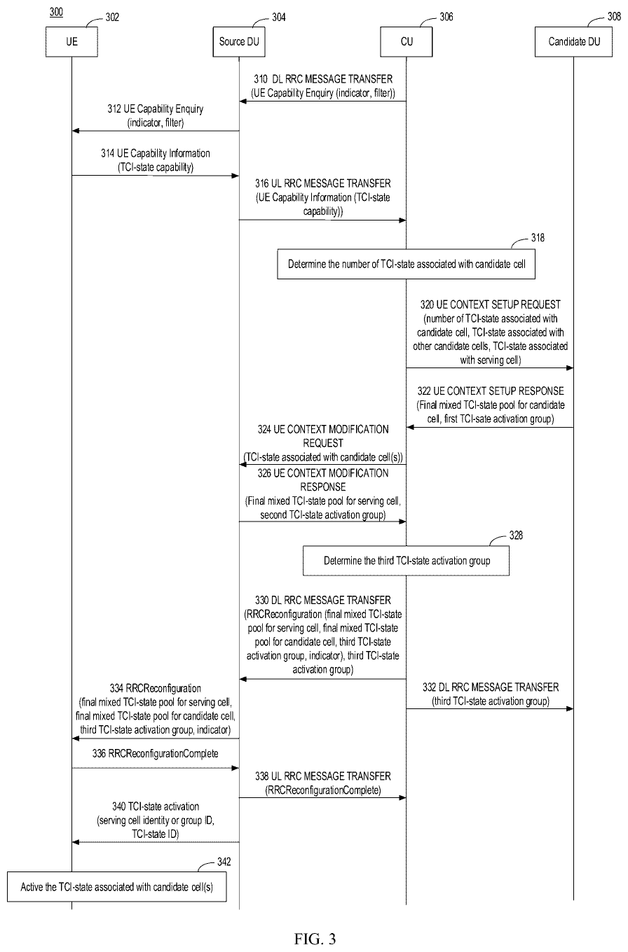

At 208, the base station 204 may determine a TCI state pool 210 based on the plurality of TCI states. The TCI state pool 210 provides a mapping of each TCI state to the associated candidate cell or the other candidate cells or the serving cell, or any combination of the above items. The details of determining the TCI state pool 210, and the mapping of each TCI state to the associated candidate cell or the other candidate cells or the serving cell will be discussed with reference to FIGS. 3-9. The base station 204 transmits (212) the TCI state pool 210 to the UE 202. The UE 202 receives (214) the TCI state pool 210 from the base station 204.

By implementing the example embodiments of FIG. 2, the index conflict or index confusion among different DUs (source DU or candidate DU) can be avoided, and the UE can have a common understanding of the TCI state indexes.

FIG. 3 illustrates an example signalling procedure 300 for determining a TCI state pool where the TCI state pool for a serving cell and the TCI state pool for a candidate cell is generated separately in accordance with aspects of the present disclosure. The signalling procedure 300 may relate to a UE 302, a source DU 304, a CU 306 and a candidate DU 308. The source DU 304, the CU 306 and the candidate DU 308 may be included in a same or different network device. The signalling procedure 300 shows the scenario that the final mixed TCI state pool for the serving cell is generated by the source DU 304, while the final mixed TCI state pool for the candidate cell is generated by the candidate DU 308, separately.

At 310, the CU 306 may send the UE capability enquiry to the source DU 304 when the CU 306 needs the UE TCI state capability information. In some example embodiment, an indicator may be included in the UE capability enquiry which may indicate the TCI state capability. The TCI state capability may be the UE capability of TCI state for LTM. In some example embodiment, the TCI state capability may further include a filter. The filter may be the information by which the CU 306 requests the UE 302 to filter the TCI state capabilities. The filter may include at least one of TCI state type and maximum number of TCI state. The TCI state type may indicate the type of TCI state activation that the UE 302 supports for LTM, for example, a mixed TCI state pool or an independent TCI state pool. The maximum number of TCI state may be that the UE 302 supports for the group of candidate cells, for each candidate cell, or for the group of serving cell and candidate cells. In some example embodiment, the UE capability enquiry may be included in the DL RRC MESSAGE TRANSFER message.

At 312, the source DU 304 may forward the received UE capability enquiry to the UE 302. At 314, the UE 302 may send the UE capability information to the source DU 304, to report the UE TCI state capability information. In some example embodiment, the UE TCI state capability information may be included in the UE capability information. The UE TCI state capability information may include at least one of the type of TCI state activation and the maximum number of TCI state.

At 316, the source DU 304 may forward the received UE capability information to the CU 306. In some example embodiment, the UE capability information may be included in the UL RRC MESSAGE TRANSFER message. It is to be noted that 310 to 316 may be optional. For example, if the CU 306 has the UE TCI state capability information, the 310 to 316 may not be needed.

At 318, the CU 306 may determine the number of TCI state to be provided for each candidate cell. In some example embodiment, the CU 306 may determine the number of TCI state for the candidate cell. Accordingly, the candidate DU 308 may prepare the TCI states for the candidate cell. The number of TCI state for one candidate cell may be different from the number of TCI state for another candidate cell. In some example embodiment, the CU 306 may determine the maximum number of TCI state for the candidate cell. Accordingly, the candidate DU 308 may prepare the TCI states for the candidate cell no more than the maximum number. The maximum number of TCI state for one candidate cell may be different from the maximum number of TCI state for another candidate cell. In some example embodiment, the number of TCI state or the maximum number of TCI state to be provided for each candidate cell or each candidate DU is up to the CU implementation, for example, based on the L1 measurement results.

At 320, the CU 306 may request the preparation of TCI states associated with the candidate cell(s) in the candidate DU(s) by sending UE CONTEXT SETUP REQUEST message including the candidate cell ID(s) to the candidate DU(s). The candidate cells may belong to the same candidate DU, or different candidate DUs. For example, the CU 306 may request the preparation of TCI states associated with the candidate cell 1 in the candidate DU 308. In some example embodiment, the UE CONTEXT SETUP REQUEST message may further include the number of TCI state or the maximum number of TCI state to be provided for the candidate cell. In some example embodiment, the number of TCI state or the maximum number of TCI state to be provided for the candidate cell may be included in the CU to DU RRC information element (IE) in the UE CONTEXT SETUP REQUEST message.

In some example embodiment, The UE CONTEXT SETUP REQUEST message may further include the TCI states associated with other candidate cells in another candidate DU or the source DU 304. For example, the UE CONTEXT SETUP REQUEST message may include the TCI states associated with the candidate cell 2 in another candidate DU. It is to be noted that the number of TCI state associated with candidate cell 2 sent to the candidate DU 308 by the CU 306 may not be more than the number of TCI state associated with candidate cell 2 sent from another candidate DU to the CU 306. For example, the number of TCI state associated with candidate cell 2 sent from another candidate DU to the CU 306 may be 128, while the number of TCI state associated with candidate cell 2 sent from another candidate DU to the CU 306 may be 16. Numbers are used for the purpose of illustration without limitation.

In some example embodiment, the UE CONTEXT SETUP REQUEST message may further include the TCI states associated with serving cell in the source DU 304. The number of TCI state associated with serving cell sent to the candidate DU 308 by the CU 306 may not be more than the number of TCI state associated with serving cell in the source DU 304. For example, the number of TCI state associated with serving cell in the source DU may 128, while the number of TCI state associated with serving cell sent to the candidate DU 308 by the CU 306 may be 16.

At 322, if the preparation request is accepted, the candidate DU 308 may respond to the CU 306 with a UE CONTEXT SETUP RESPONSE message. The UE CONTEXT SETUP RESPONSE message may include the candidate cell ID(s) that was requested from the CU 306, as well as the final mixed TCI state pool for the candidate cell(s). The final mixed TCI state pool for the candidate cell may be a mixed TCI state pool. For example, the final mixed TCI state pool for the candidate cell 1 may include the TCI states associated with the candidate cell 1 in the candidate DU, the TCI states associated with the candidate cell 2 in another candidate DU, and the TCI states associated with the serving cell in the source DU, as shown in table 1.

TABLE 1

TCI-state index 1, associated with candidate cell 1
TCI-state index 2, associated with candidate cell 2
TCI-state index 3, associated with serving cell
TCI-state index 4, associated with candidate cell 1
TCI-state index 5, associated with candidate cell 2
TCI-state index 6, associated with serving cell

In some example embodiment, the UE CONTEXT SETUP RESPONSE message may further include the first TCI state activation group determined by the candidate DU 308. The first TCI state activation group may include the identity of cell, e.g., candidate cell, serving cell. The identity of the cell may be the physical cell identity (PCI), candidate cell configuration index, or cell global identity (CGI). The candidate cell configuration index is used to uniquely identify a candidate cell configuration, e.g., LTM candidate cell configuration. In addition, the first TCI state activation group may be associated with a group ID, which is used to identify the first TCI state activation group. The candidate DU 308 may provide multiple first TCI state activation groups, where the two first TCI state activation groups may not contain same cells. In some example embodiment, the final mixed TCI state pool for the candidate cell and the first TCI state activation group may be included in the DU to CU RRC Information IE in the UE CONTEXT SETUP RESPONSE message.

At 324, the CU 306 may send a UE CONTEXT MODIFICATION REQUEST message containing the TCI states associated with the candidate cell(s) to the source DU 304. In some example embodiment, the UE CONTEXT MODIFICATION REQUEST message may contain the TCI states associated with the candidate cell 1 in the candidate DU 308, and the TCI states associated with the candidate cell 2 in another candidate DU. It is to be noted that the number of TCI states associated with the candidate cell 1 or candidate cell 2 sent to the source DU 304 by the CU 306 may not be more than the number of TCI states associated with the candidate cell 1 or candidate cell 2 received by the CU 306 from the candidate DU 308 and/or other candidate DU.

At 326, if the request is accepted, the source DU 304 may respond to the CU 306 with a UE CONTEXT MODIFICATION RESPONSE message, which may contain the final mixed TCI state pool for the serving cell. In some example embodiment, the final mixed TCI state pool for the serving cell may be a mixed TCI state pool. For example, the final mixed TCI state pool for the serving cell may include the TCI states associated with the serving cell in the source DU 304, the TCI states associated with the candidate cell 1 in the candidate DU, and the TCI states associated with the candidate cell 2 in another candidate DU, as shown in table 2.

TABLE 2

TCI-state index 1, associated with serving cell
TCI-state index 2, associated with candidate cell 1
TCI-state index 3, associated with candidate cell 2
TCI-state index 4, associated with serving cell
TCI-state index 5, associated with candidate cell 1
TCI-state index 6, associated with candidate cell 2

In some example embodiment, the UE CONTEXT MODIFICATION RESPONSE message may further include a second TCI state activation group determined by the source DU 304. The second TCI state activation group may include the identity of cell, e.g., serving cell, candidate cell. The identify of cell may be the PCI, candidate cell configuration index, or CGI. In addition, the second TCI state activation group may be associated with a group ID, which is used to identify the second TCI state activation group. The source DU 304 may provide multiple second TCI state activation groups, where the two second TCI state activation groups may not contain same cells. It is to be noted that 324 and 326 may be executed before 320 and 322.

At 328, the CU 306 may determine a third TCI state activation group. In some example embodiment, if the candidate DU 308 provides the first TCI state activation group in 322, the third TCI state activation group may be the same with the first TCI state activation group. In some example embodiment, if the source DU 304 provides the second TCI state activation group in step 326, the third TCI state activation group may be the same with the second TCI state activation group. In some example embodiment, the third TCI state activation group may be different from the first TCI state activation group and the second TCI state activation group.

At 330, the CU 306 may send a DL RRC MESSAGE TRANSFER message to the source DU 304, which may include a generated RRCReconfiguration message. In some example embodiment, the RRCReconfiguration message may include the final mixed TCI state pool for the serving cell and the final mixed TCI state pool for the candidate cell. There may be multiple final mixed TCI state pools, where each final mixed TCI state pool is for each candidate cell. In some example embodiment, the RRCReconfiguration message may further include the third TCI state action group.

In some example embodiment, the RRCReconfiguration message may further include an indicator. The indicator may indicate that the final mixed TCI state pool for the serving cell and/or the final mixed TCI state pool for the candidate cell may be used when the UE 302 moves to the candidate cell. That is, the UE 302 may not release the final mixed TCI state pool for the serving cell and/or the final mixed TCI state pool for the candidate cell during the cell switch. In some example embodiment, the DL RRC MESSAGE TRANSFER message may further include the third TCI state activation group. In some example embodiment, the CU 306 may send the RRCReconfiguration message and the third TCI state activation group to the source DU 304 via other message, e.g., UE CONTEXT MODIFICATION REQUEST message.

At 332, The CU 306 may also send a DL RRC MESSAGE TRANSFER message to the candidate DU 308 containing the third TCI state activation group. In some example embodiment, the CU 306 may send the third TCI state activation group to the candidate DU 308 via other message, e.g., UE CONTEXT MODIFICATION REQUEST message. It is to be noted that 332 may be executed before 330.

At 334, the source DU 304 may forward the RRCReconfiguration message to the UE 302. In some example embodiment, if the third TCI state activation group is included in the 330, the source DU 304 may store the third TCI state activation group.

At 336, the UE 302 may respond to the source DU 304 with a RRCReconfigurationComplete message. At 338, the source DU 304 may forward the RRCReconfigurationComplete message to the CU via an UL RRC MESSAGE TRANSFER message. In some example embodiment, the source DU 304 may forward the RRCReconfigurationComplete message to the CU 306 via other message, e.g., UE CONTEXT MODIFICATION RESPONSE message.

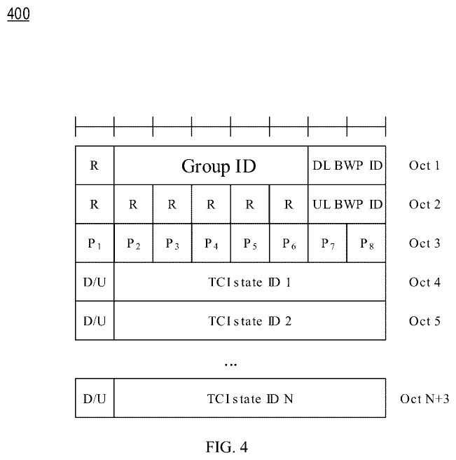

At 340, if the source DU 304 determines that the TCI state activation for the candidate cell(s) is needed, the source DU 304 may send a TCI state activation command including the TCI state index(es) to the UE 302. In some example embodiment, the TCI state activation command may include the identity of serving cell. In some example embodiment, the TCI state activation command may include the group ID of the third TCI state activation group. In some example embodiment, the TCI state activation command may include the identity of candidate cell. For example, the TCI state activation command is shown in FIG. 4.

FIG. 4 illustrates an example group ID 400 of TCI states to be activated in accordance with aspects of the present disclosure. As shown in FIG. 4, the TCI state activation group may be determined by the CU, the source DU or the candidate DU. In some example embodiment, a group ID may be introduced to identify the TCI state activation group containing multiple candidate cells. The TCI state activation command (e.g., MAC CE) may include the group ID. With this, the TCI state activation command may apply to all the candidate cells in the TCI state activation group by the UE. In some example embodiment, the TCI state activation command may be a MAC CE.

Referring back to FIG. 3, at 342, the UE 302 may activate the TCI state(s) associated with the candidate cell. In some example embodiment, if the TCI state activation command includes the identify of serving cell, and the serving cell is not within the third TCI state activation group, the UE 302 may activate the corresponding TCI state(s) based on the TCI state index(es).

In some example embodiment, if the TCI state activation command includes the identify of serving cell, and the serving cell is within the third TCI state activation group, the TCI state activation command may apply to all the candidate cells in the third TCI state activation group. That is, the UE 302 may activate the corresponding TCI state(s) associated to all the candidate cell(s) in the third TCI state activation group, based on the TCI state index(es). For example, the TCI state activation command may include the TCI state index 1, and the serving cell and the candidate cell 1 are in the same third TCI state activation group, the UE 302 may activate the TCI state index 1 in the final mixed TCI state pool for the serving cell, and also may activate the TCI state index 1 in the final mixed TCI state pool for the candidate cell 1.

In some example embodiment, if the TCI state activation command includes the group ID, the TCI state activation command may apply to all the candidate cells in the third TCI state activation group. That is, the UE 302 may activate the corresponding TCI state(s) associated to all the candidate cell(s) in the third TCI state activation group, based on the TCI state index(es). For example, the TCI state activation command may include the TCI state index 1, and the serving cell and the candidate cell 1 are in the same third TCI state activation group, the UE 302 may activate the TCI state index 1 in the final mixed TCI state pool for the serving cell, and also activates the TCI state index 1 in the final mixed TCI state pool for the candidate cell 1.

In some example embodiment, if the TCI state activation command includes the identify of candidate cell, and the candidate cell is not within the third TCI state activation group, the UE 302 may activate the corresponding TCI state(s) based on the TCI state index(es).

In some example embodiment, if the TCI state activation command includes the identify of candidate cell, and the candidate cell is within the third TCI state activation group, the TCI state activation command may apply to all the candidate cells in the third TCI state activation group. That is, the UE 302 may activate the corresponding TCI state(s) associated to all the candidate cell(s) in the third TCI state activation group, based on the TCI state index(es). For example, the TCI state activation command may include the TCI state index 1, and the candidate cell 1 and the candidate cell 2 are in the same third TCI state activation group, the UE 302 may activate the TCI state index 1 in the final mixed TCI state pool for the candidate cell 1, and also may activate the TCI state index 1 in the final mixed TCI state pool for the candidate cell 2.

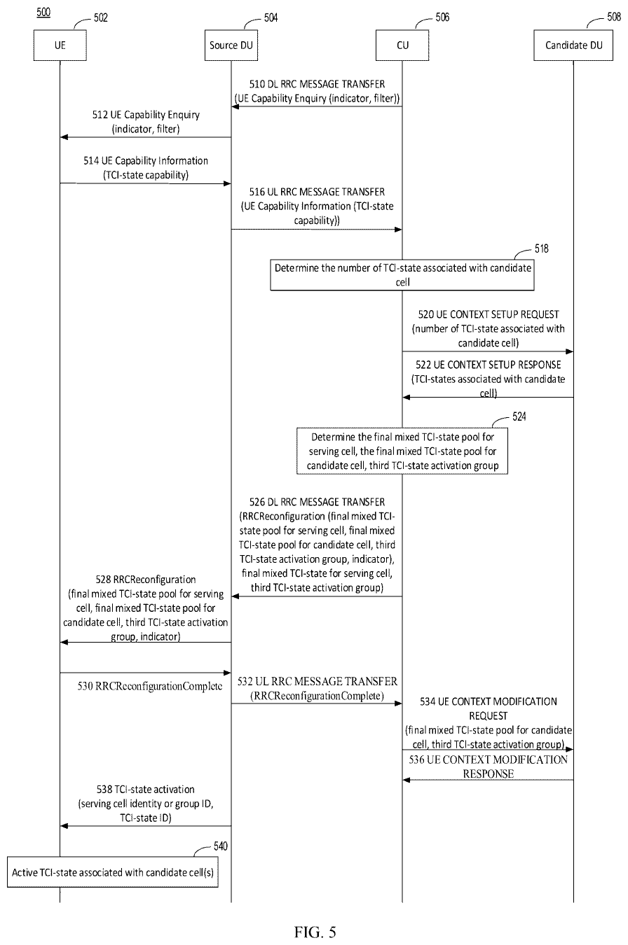

FIG. 5 illustrates an example signalling procedure 500 for determining a TCI state pool where the TCI state pool for a serving cell and the TCI state pool for a candidate cell is generated by the CU in accordance with aspects of the present disclosure. The signalling procedure 500 may relate to a UE 502, a source DU 504, a CU 506 and a candidate DU 508. The source DU 504, the CU 506 and the candidate DU 508 may be included in a same or different network device. The signalling procedure 500 shows the scenario that the final mixed TCI state pool for the serving cell and the final mixed TCI state pool for the candidate cell are generated by the CU 506.

In FIG. 5, step 510 may correspond to step 310 in FIG. 3. Step 512 may correspond to step 312 in FIG. 3. Step 514 may correspond to step 314 in FIG. 3. Step 516 may correspond to step 316 in FIG. 3. Step 518 may correspond to step 318 in FIG. 3. In the purpose of simplification, the details of steps 510-518 will not be discussed again.

At 520, the CU 506 may request the preparation of TCI states associated with the candidate cell(s) in the candidate DU(s) by sending UE CONTEXT SETUP REQUEST message including the candidate cell ID(s) to the candidate DU(s). It is to be noted that the candidate cells may belong to the same candidate DU, or different candidate DUs. For example, the CU 506 may request the preparation of TCI states associated with the candidate cell 1 in the candidate DU 508. In some example embodiment, the UE CONTEXT SETUP REQUEST message may further include the number of TCI state or the maximum number of TCI state to be provided for the candidate cell. In some example embodiment, the number of TCI state or the maximum number of TCI state to be provided for the candidate cell is included in the CU to DU RRC Information IE in the UE CONTEXT SETUP REQUEST message.

At 522, if the preparation request is accepted, the candidate DU 508 may respond to the CU 506 with a UE CONTEXT SETUP RESPONSE message. The UE CONTEXT SETUP RESPONSE message may include the candidate cell ID(s) that was requested from the CU 506, as well as the TCI states associated with the candidate cell(s). For example, the UE CONTEXT SETUP RESPONSE message may include the TCI states with the indexes 0~16 associated with the candidate cell 1.

At 524, the CU 506 may determine the final mixed TCI state pool for the serving cell, and the final mixed TCI state pool for the candidate cell. In some example embodiment, the final mixed TCI state pool for the serving cell may be a mixed TCI state pool. For example, the final mixed TCI state pool for the serving cell may include the TCI states associated with the serving cell in the source DU 504, the TCI states associated with the candidate cell 1 in the candidate DU 508, and the TCI states associated with the candidate cell 2 in another candidate DU, as shown in table 3.

TABLE 3

TCI-state index 1, associated with serving cell
TCI-state index 2, associated with candidate cell 1
TCI-state index 3, associated with candidate cell 2
TCI-state index 4, associated with serving cell
TCI-state index 5, associated with candidate cell 1
TCI-state index 6, associated with candidate cell 2

In some example embodiments, the final mixed TCI state pool for the candidate cell may be a mixed TCI state pool. For example, the final mixed TCI state pool for the candidate cell 1 may include the TCI states associated with the candidate cell 1 in the candidate DU 508, the TCI states associated with the candidate cell 2 in another candidate DU, and the TCI states associated with the serving cell in the source DU 504, as shown in table 4.

TABLE 4

TCI-state index 1, associated with candidate cell 1
TCI-state index 2, associated with candidate cell 2
TCI-state index 3, associated with serving cell
TCI-state index 4, associated with candidate cell 1
TCI-state index 5, associated with candidate cell 2
TCI-state index 6, associated with serving cell

In some example embodiments, the final mixed TCI state pool for the serving cell is the same with the final mixed TCI state pool for the candidate cell. In this case, there may be one final mixed TCI state pool, which is for both the serving cell and the candidate cell. In some example embodiments, The CU 506 may further determine the third TCI state activation group. The third TCI state activation group may include the identities of cells, e.g., candidate cell, serving cell. The identify of cell may be the PCI, candidate cell configuration index, or CGI. In addition, the third TCI state activation group may be associated with a group ID, which may be used to identify the third TCI state activation group. The CU 506 may provide multiple third TCI state activation groups, where the two third TCI state activation groups may not contain same cells.

At 526, the CU 506 may send a DL RRC MESSAGE TRANSFER message to the source DU 504, which may include a generated RRCReconfiguration message. In some example embodiments, The RRCReconfiguration message may include the final mixed TCI state pool for the serving cell and the final mixed TCI state pool for the candidate cell. In some example embodiments, there may be multiple final mixed TCI state pools, where each final mixed TCI state pool may be for each candidate cell.

In some example embodiments, the RRCReconfiguration message may further include the third TCI state action group. In some example embodiments, the RRCReconfiguration message may further include an indicator. The indicator may indicate the final mixed TCI state pool for the serving cell and/or the final mixed TCI state pool for the candidate cell may be used when the UE 502 moves to the candidate cell. That is, the UE 502 may not release the final mixed TCI state pool for the serving cell and/or the final mixed TCI state pool for the candidate cell during the cell switch.

In some example embodiments, the DL RRC MESSAGE TRANSFER message may further include the final mixed TCI state pool for the serving cell. In some example embodiments, the DL RRC MESSAGE TRANSFER message may further include the third TCI state activation group. It is to be noted that the CU 506 may send the RRCReconfiguration message, the mixed TCI state pool for the serving cell and the third TCI state activation group to the source DU 504 via other message, e.g., UE CONTEXT MODIFICATION REQUEST message.

Step 528 may correspond to step 334 in FIG. 3. Step 530 may correspond to 336 in FIG. 3. Step 532 may correspond to step 336 in FIG. 3. In the purpose of simplification, the details of steps 528-532 will not be discussed again. At 534, the CU 506 may send a UE CONTEXT MODIFICATION REQUEST message containing the final mixed TCI-stat pool for the candidate cell(s) to the candidate DU 508. The UE CONTEXT MODIFICATION REQUEST message may further include the third TCI state activation group. It is to be noted that the CU 506 may send the final mixed TCI state pool for the candidate cell(s) and/or the third TCI state activation group to the candidate DU via other message, e.g., DL RRC MESSAGE TRANSFER message.

At step 536, if the request is accepted, the candidate DU 508 may respond to the CU 306 with a UE CONTEXT MODIFICATION RESPONSE message. It is to be noted that if the step 534 uses a DL RRC MESSAGE TRANSFER message, step 536 may use the UL RRC MESSAGE TRANSFER message, otherwise 536 may not be needed. It is also to be noted that 534 and 536 may be executed before steps 526-532. Step 536 may correspond to 340 in FIG. 3. 540 may correspond to 342 in FIG. 3. In the purpose of simplification, the details of 538-540 will not be discussed again.

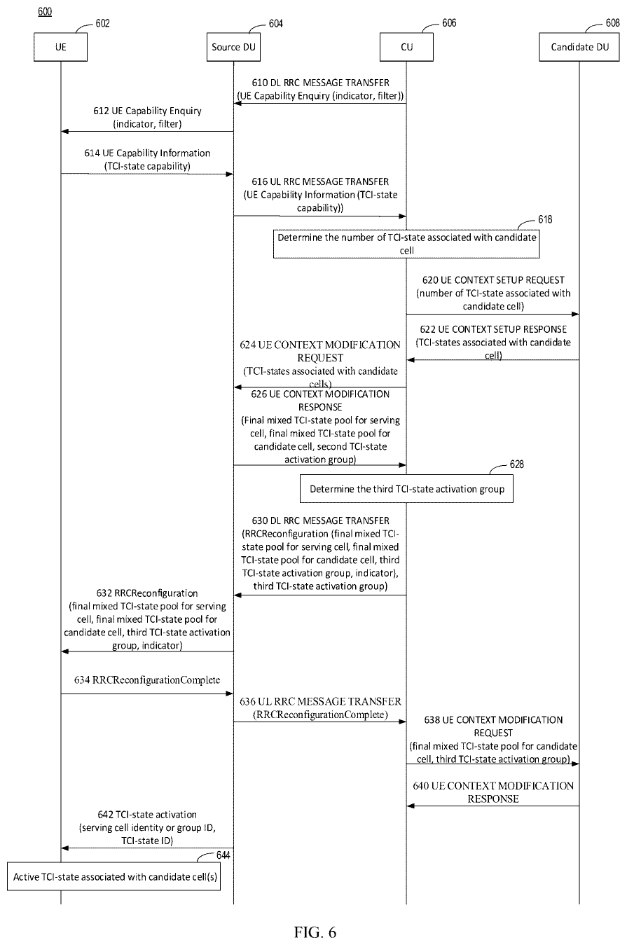

FIG. 6 illustrates an example signalling procedure 600 for determining a TCI state pool where the TCI state pool for a serving cell and the TCI state pool for a candidate cell is generated by the source DU in accordance with aspects of the present disclosure. The signalling procedure 600 may relate to a UE 602, a source DU 604, a CU 606 and a candidate DU 608. The source DU 604, the CU 606 and the candidate DU 608 may be included in a same or different network device. The signalling procedure 600 shows the scenario that the final mixed TCI state pool for the serving cell and the final mixed TCI state pool for the candidate cell are generated by the source DU 604.

In FIG. 6, Step 610 may correspond to step 510 in FIG. 5. Step 612 may correspond to step 512 in FIG. 5. Step 614 may correspond to step 514 in FIG. 5. Step 616 may correspond to step 516 in FIG. 5. Step 618 may correspond to step 518 in FIG. 5. Step 620 may correspond to step 520 in FIG. 5. Step 622 may correspond to step 522 in FIG. 5. In the purpose of simplification, the details of steps 610-622 will not be discussed again.

At 624, the CU 606 may send a UE CONTEXT MODIFICATION REQUEST message containing the TCI states associated with the candidate cell(s) to the source DU 604. At 626, if the request is accepted, the source DU 604 may respond to the CU 606 with a UE CONTEXT MODIFICATION RESPONSE message.

In some example embodiments, the UE CONTEXT MODIFICATION RESPONSE message may include the final mixed TCI state pool for the serving cell. In some example embodiments, the UE CONTEXT MODIFICATION RESPONSE message may include the final mixed TCI state pool for the candidate cell. In some example embodiments, the final mixed TCI state pool for the serving cell may be the same with the final mixed TCI state pool for the candidate cell. In this case, there may be only one final mixed TCI state pool, which may be for both the serving cell and the candidate cell.

In some example embodiments, the UE CONTEXT MODIFICATION RESPONSE message may further include the second TCI state activation group determined by the source DU 604. The second TCI state activation group includes the identities of cells, e.g., serving cell, candidate cell(s). The identify of candidate cell/serving cell may be the PCI, candidate cell configuration index, or CGI. In addition, the second TCI state activation group may be associated with a group ID, which may be used to identify the second TCI state activation group. The source DU 604 may provide multiple second TCI state activation groups, where the two second TCI state activation groups may not contain same cells.

At 628, the CU may determine a third TCI state activation group. In some example embodiments, if the source DU 604 provides the second TCI state activation group in step 624, the third TCI state activation group may be the same with the second TCI state activation group. In some example embodiments, the third TCI state activation group may be different from the second TCI state activation group.

At 630, the CU 606 may send a DL RRC MESSAGE TRANSFER message to the source DU 604, which may include a generated RRCReconfiguration message. In some example embodiments, the RRCReconfiguration message may include the final mixed TCI state pool for the serving cell and the final mixed TCI state pool for the candidate cell. There may be multiple final mixed TCI state pools, where each final mixed TCI state pool is for each candidate cell. In some example embodiments, the RRCReconfiguration message may further include the third TCI state action group.

In some example embodiments, the RRCReconfiguration message may further include an indicator. The indicator may indicate the final mixed TCI state pool for the serving cell and/or the final mixed TCI state pool for the candidate cell may be used when the UE 602 moves to the candidate cell. That is, the UE 602 may not release the final mixed TCI state pool for the serving cell and/or the final mixed TCI state pool for the candidate cell during the cell switch. In some example embodiments, the DL RRC MESSAGE TRANSFER message may further include the third TCI state activation group. It is to be noted that the CU 606 may send the RRCReconfiguration message and the third TCI state activation group to the source DU 604 via other message, e.g., UE CONTEXT MODIFICATION REQUEST message.

Step 632 may correspond to step 528 in FIG. 5. Step 634 may correspond to step 530 in FIG. 5. Step 636 may correspond to step 532 in FIG. 5. Step 638 may correspond to step 534 in FIG. 5. Step 640 may correspond to step 536 in FIG. 5. Step 642 may correspond to step 538 in FIG. 5. Step 644 may correspond to step 540 in FIG. 5. In the purpose of simplification, the details of steps 632-644 will not be discussed again.

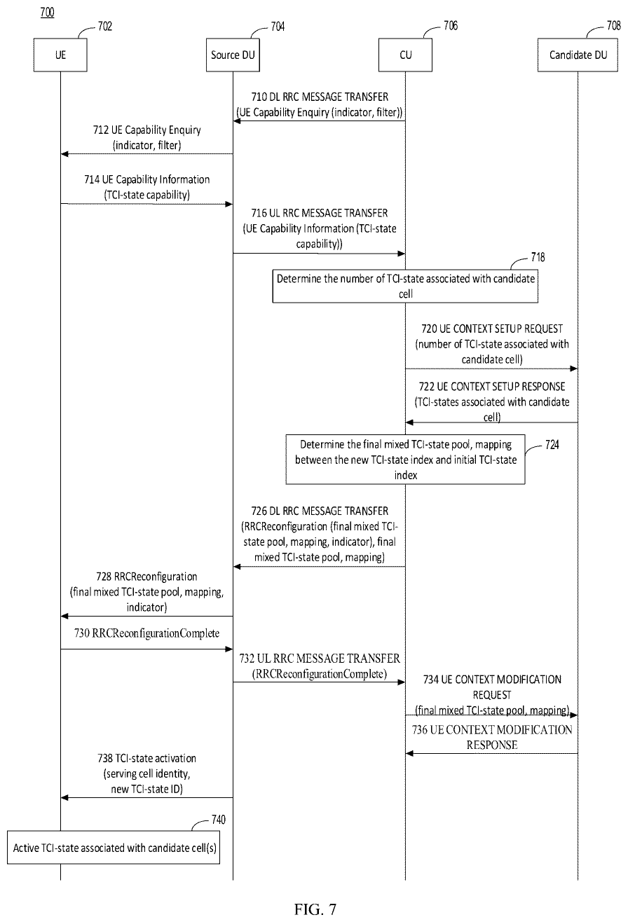

FIG. 7 illustrates an example signalling procedure 700 for determining a TCI state pool where new TCI state indexes are used in accordance with aspects of the present disclosure. The signalling procedure 700 may relate to a UE 702, a source DU 704, a CU 706 and a candidate DU 708. The source DU 704, the CU 706 and the candidate DU 708 may be included in a same or different network device. The signalling procedure 700 shows the scenario that there is only final mixed TCI state pool, for both the serving cell and the candidate cell(s). The TCI state index in the final mixed TCI state pool is the same with the TCI state index received from the source DU and the candidate DU.

In FIG. 7, step 710 may correspond to step 510 in FIG. 5. Step 712 may correspond to step 512 in FIG. 5. Step 714 may correspond to step 514 in FIG. 5. Step 716 may correspond to step 516 in FIG. 5. Step 718 may correspond to step 518 in FIG. 5. Step 720 may correspond to step 520 in FIG. 5. Step 722 may correspond to step 522 in FIG. 5. In the purpose of simplification, the details of steps 710-722 will not be discussed again.

At 724, the CU 706 may determine the final mixed TCI state pool. In some example embodiments, the final mixed TCI state pool may be for both the serving cell and candidate cell, without changing the TCI state indexes associated with the serving cell and the TCI state indexes associated with the candidate cell. In some example embodiments, the CU 706 may further determine the new TCI state index for the TCI state associated with the serving cell or candidate cell. In some example embodiments, the TCI state pool is shown as table 5.

TABLE 5

New TCI-state index 1, initial TCI-state index 1, associated with
serving cell
New TCI-state index 2, initial TCI-state index 2, associated with
serving cell
New TCI-state index 3, initial TCI-state index 1, associated with
candidate cell 1
New TCI-state index 4, initial TCI-state index 2, associated with
candidate cell 1
New TCI-state index 5, initial TCI-state index 1, associated with
candidate cell 2
New TCI-state index 6, initial TCI-state index 2, associated with
candidate cell 2

At 726, the CU 706 may send a DL RRC MESSAGE TRANSFER message to the source DU 704, which may include a generated RRCReconfiguration message. In some example embodiments, the RRCReconfiguration message may include the final mixed TCI state pool. In some example embodiments, the RRCReconfiguration message may further include an indicator. The indicator may indicate the final mixed TCI state pool may be used when the UE 702 moves to the candidate cell. That is, the UE 702 may not release the final mixed TCI state pool during the cell switch.

In some example embodiments, the RRCReconfiguration message may further include a mapping between the new TCI state index and the initial TCI state index. For example, the mapping between the new TCI state index and the initial TCI state index may be explicitly configured, e.g., via <new TCI state index, initial TCI state index, serving cell/candidate cell identity>.

In some example embodiments, the DL RRC MESSAGE TRANSFER message may further include the final mixed TCI state pool. In some example embodiments, the DL RRC MESSAGE TRANSFER message may further include the mapping between the new TCI state index and the initial TCI state index. It is to be noted that the CU 706 may send the RRCReconfiguration message, the final mixed TCI state pool and the mapping between the new TCI state index and the initial TCI state index to the source DU via other message, e.g., UE CONTEXT MODIFICATION REQUEST message.

At 728, the source DU 704 may store the final mixed TCI state pool, and may forward the RRCReconfiguration message to the UE 702. In some example embodiments, if the mapping between the new TCI state index and the initial TCI state index is included in 726, the source DU may store the mapping between the new TCI state index and the initial TCI state index.

At 730, the UE 702 may respond to the source DU 704 with a RRCReconfigurationComplete message. At 732, the source DU 704 may forward the RRCReconfigurationComplete message to the CU 706 via an UL RRC MESSAGE TRANSFER message. It is to be noted that the source DU 704 may forward the RRCReconfigurationComplete message to the CU 706 via other message, e.g., UE CONTEXT MODIFICATION RESPONSE message.

At 734, the CU 706 may send a UE CONTEXT MODIFICATION REQUEST message containing the final mixed TCI-stat pool to the candidate DU 708. In some example embodiments, The UE CONTEXT MODIFICATION REQUEST message may further include the mapping between the new TCI state index and the initial TCI state index. It is to be noted that the CU 706 may could the final mixed TCI state pool, the mapping between the new TCI state index and the initial TCI state index and the third TCI state activation group to the candidate DU 708 via other message, e.g., DL RRC MESSAGE TRANSFER message.

At 736, if the request is accepted, the candidate DU 708 may respond to the CU 706 with a UE CONTEXT MODIFICATION RESPONSE message. It is to be noted that if the step 734 uses a DL RRC MESSAGE TRANSFER message, 736 may use the UL RRC MESSAGE TRANSFER message, otherwise step 736 may not be needed. It is also to be noted that step 734 and 736 may be executed before 726-732.

At 738, if the source DU 704 determines that the TCI state activation for the candidate cell(s) is needed, the source DU 704 may send a TCI state activation command to the UE 702. In some example embodiments, the TCI state activation command may include the serving cell identity and the new TCI state index(es). In some example embodiments, the TCI state activation command may be a MAC CE.

At 740, the UE 702 may activate the TCI state(s) associated with the candidate cell. In some example embodiments, if the mapping between the new TCI state index and the initial TCI state index is included in the RRCReconfiguration message in step 728, the UE 702 may determine the initial TCI state index based on the mapping, and then the UE 702 may activate the TCI state associated with the candidate cell that is identified by the initial TCI state index. For example, the new TCI state index may be 6, and the mapping may be <new TCI state index 6, initial TCI state index 2 in candidate cell 1>. The UE 702 may activate the TCI state identified by TCI state index 2 in the candidate cell 1. It is to be noted that the numbers are used for the purpose of the illustration without limitation.

In some example embodiments, if the mapping between the new TCI state index and the initial TCI state index is not included in the RRCReconfiguration message in the 728, the UE 702 may determine the initial TCI state index based on the order of TCI states. For example, the order of TCI states is shown as table 6.

TABLE 6

initial TCI-state index 1, associated with serving cell
initial TCI-state index 2, associated with serving cell
initial TCI-state index 1, associated with candidate cell 1
initial TCI-state index 2, associated with candidate cell 1
initial TCI-state index 1, associated with candidate cell 2
initial TCI-state index 2, associated with candidate cell 2

In some example embodiments, if the new TCI state index in the TCI state activation command is 3, the UE may determine the initial TCI state index is 2 in the candidate cell 1. That is, if the new TCI state index in the TCI state activation command is N, the UE 702 may determine the TCI state to be activated is the (N+1) TCI state in the order of TCI states. It is to be noted that the numbers are used for the purpose of the illustration without limitation.

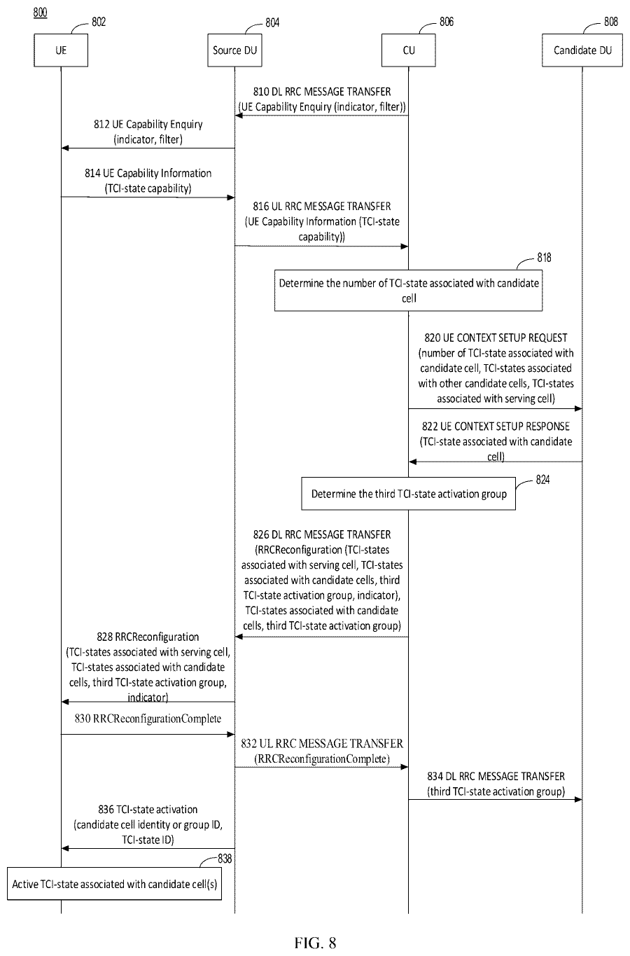

FIG. 8 illustrates an example signalling procedure 800 for determining a TCI state pool where the TCI state pool for a serving cell and the TCI state pool for a candidate cell are organized independently in accordance with aspects of the present disclosure. The signalling procedure 800 may relate to a UE 802, a source DU 804, a CU 806 and a candidate DU 808. The source DU 804, the CU 806 and the candidate DU 808 may be included in a same or different network device. The signalling procedure 800 shows the scenario that the TCI state pool for serving cell and the TCI state pool for candidate cell are organized independently, while the TCI state pool is an independent TCI state pool.

In FIG. 8, step 810 may correspond to step 310 in FIG. 3. Step 812 may correspond to step 312 in FIG. 3. Step 814 may correspond to step 314 in FIG. 3. Step 816 may correspond to step 316 in FIG. 3. Step 818 may correspond to step 318 in FIG. 3. Step 820 may correspond to step 320 in FIG. 3. In the purpose of simplification, the details of steps 810-820 will not be discussed again.

At 822, if the preparation request is accepted, the candidate DU 808 may respond to the CU 806 with a UE CONTEXT SETUP RESPONSE message. In some example embodiments, the UE CONTEXT SETUP RESPONSE message may include the candidate cell ID(s) that was requested from the CU, as well as the TCI states associated with the candidate cell(s).

At 824, the CU 806 may determine the third TCI state activation group. The third TCI state activation group may include the identities of cells, e.g., candidate cell, serving cell. The identify of cell may be the PCI, candidate cell configuration index, or CGI. In addition, the third TCI state activation group may be associated with a group ID, which may be used to identify the third TCI state activation group. The CU 806 may provide multiple third TCI state activation groups, where the two third TCI state activation groups shall not contain same cells.

At 826, the CU 806 may send a DL RRC MESSAGE TRANSFER message to the source DU, which may include a generated RRCReconfiguration message. In some example embodiments, the RRCReconfiguration message may include the TCI states associated with the candidate cell(s) and the TCI states associated with the serving cell. In some example embodiments, the RRCReconfiguration message may further include the third TCI state action group. In some example embodiments, the RRCReconfiguration message may further include an indicator. The indicator may indicate the TCI states associated with the candidate cell(s) and/or serving cell may be used when the UE 802 moves to the candidate cell. That is, the UE 802 may not release the TCI states associated with the candidate cell(s) and/or serving cell during the cell switch.

In some example embodiments, the DL RRC MESSAGE TRANSFER message may further include the TCI states associated with the candidate cell(s). In some example embodiments, the DL RRC MESSAGE TRANSFER message may further include the third TCI state activation group. It is to be noted that the CU 806 may send the RRCReconfiguration message, the TCI states associated with the candidate cell(s) and the third TCI state activation group to the source DU 804 via other message, e.g., UE CONTEXT MODIFICATION REQUEST message.

At 828, the source DU 804 may store the TCI states associated with the candidate cell(s), and may forward the RRCReconfiguration message to the UE 802. In some example embodiments, if the third TCI state activation group is included in 826, the source DU may store the third TCI state activation group.

At 830, the UE 802 may respond to the source DU 804 with a RRCReconfigurationComplete message. At 832, the source DU 804 may forward the RRCReconfigurationComplete message to the CU 806 via an UL RRC MESSAGE TRANSFER message. It is to be noted that the source DU 804 may forward the RRCReconfigurationComplete message to the CU 806 via other message, e.g., UE CONTEXT MODIFICATION RESPONSE message.

At 834, the CU 806 may send a DL RRC MESSAGE TRANSFER message to the candidate DU containing the third TCI state activation group. It is to be noted that the CU 806 may send the third TCI state activation group to the candidate DU 808 via other message, e.g., UE CONTEXT MODIFICATION REQUEST message. It is also to be noted that 834 may be executed before 826.

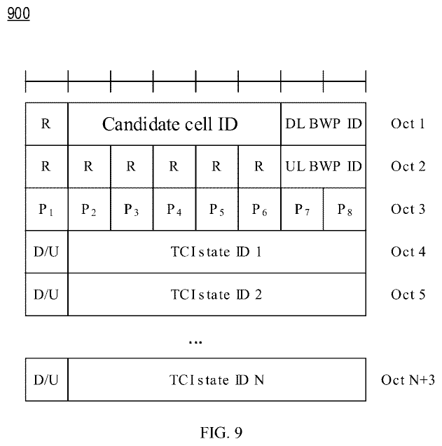

At 836, if the source DU 804 may determine that the TCI state activation for the candidate cell(s) is needed, the source DU 804 may send a TCI state activation command including the TCI state index(es) to the UE 802. In some example embodiments, the TCI state activation command includes the identity of candidate cell, e.g., PCI, candidate cell configuration index, CGI. For example, the TCI state activation command is shown in FIG. 9. FIG. 9 illustrates an example command 900 to activate TCI states in accordance with aspects of the present disclosure.

As shown in FIG. 9, a TCI state activation group containing multiple candidate cells is introduced, e.g., in the RRC modelling. The TCI state activation command (e.g., MAC CE) may include the identity of the candidate cell (e.g., candidate cell configuration index, PCI, CGI). If the candidate cell is configured as part of the TCI state activation group, the TCI state activation command also applies to all the candidate cells in the TCI state activation group by the UE. The TCI state activation group may be determined by the CU, source DU or candidate DU. In some example embodiments, the TCI state activation command may include the group ID of the third TCI state activation group, as shown in FIG. 4. In some example embodiments, the TCI state activation command may be a MAC CE.

Referring back to FIG. 8, at 838, the UE 802 may activate the TCI state(s) associated with the candidate cell. In some example embodiments, if the TCI state activation command includes the identify of candidate cell, and the candidate cell is not within the third TCI state activation group, the UE 802 may activate the corresponding TCI state(s) based on the TCI state index(es).

In some example embodiments, if the TCI state activation command includes the identify of candidate cell, and the candidate cell is within the third TCI state activation group, the TCI state activation command may apply to all the candidate cells in the third TCI state activation group. That is, the UE 802 may activate the corresponding TCI state(s) associated to all the candidate cell(s) in the third TCI state activation group, based on the TCI state index(es). For example, the TCI state activation command may include the identity of the candidate cell 1 and the TCI state index 1, and the candidate cell 1 and the candidate cell 2 may be in the same third TCI state activation group, the UE 802 may activate the TCI state associated with the candidate cell 1 identified by the index 1, and may activate the TCI state associated with the candidate cell 2 identified by the index 1.

In some example embodiments, if the TCI state activation command includes the group ID, the TCI state activation command applies to all the candidate cells in the third TCI state activation group. That is, the UE 802 may activate the corresponding TCI state(s) associated to all the candidate cell(s) in the third TCI state activation group, based on the TCI state index(es). For example, the TCI state activation command may include the TCI state index 1, and the candidate cell 1 and the candidate cell 2 may be in the same third TCI state activation group. The UE 802 may activate the TCI state associated with the candidate cell 1 identified by the index 1, and may activate the TCI state associated with the candidate cell 2 identified by the index 1.

It is to be understood that although FIGS. 3-9 are described for the inter-CU LTM, all the information changed between the CU and the candidate DU are also exchanged between the different CUs, for all the embodiments included in the present disclosure.

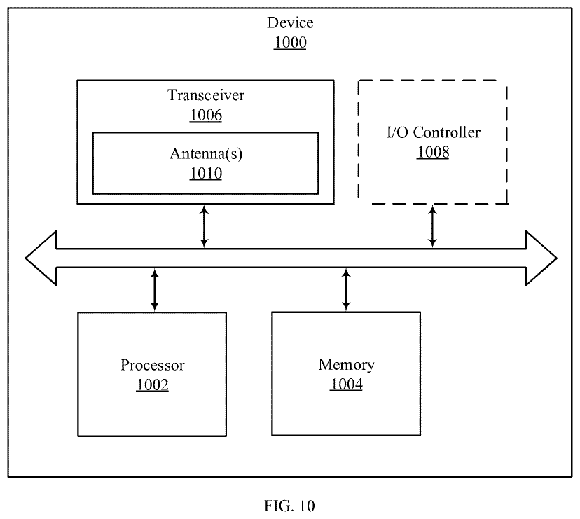

FIG. 10 illustrates an example of a device 1000 that supports the solution for determining a TCI state pool in accordance with aspects of the present disclosure. The device 1000 may be an example of a network entity 102 as described herein. The device 1000 may support wireless communication with one or more network entities 102, UEs 104, or any combination thereof. The device 1000 may include components for bi-directional communications including components for transmitting and receiving communications, such as a processor 1002, a memory 1004, a transceiver 1006, and, optionally, an I/O controller 1008. These components may be in electronic communication or otherwise coupled (e.g., operatively, communicatively, functionally, electronically, electrically) via one or more interfaces (e.g., buses).

The processor 1002, the memory 1004, the transceiver 1006, or various combinations thereof or various components thereof may be examples of means for performing various aspects of the present disclosure as described herein. For example, the processor 1002, the memory 1004, the transceiver 1006, or various combinations or components thereof may support a method for performing one or more of the operations described herein.

In some implementations, the processor 1002, the memory 1004, the transceiver 1006, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1002 and the memory 1004 coupled with the processor 1002 may be configured to perform one or more of the functions described herein (e.g., executing, by the processor 1002, instructions stored in the memory 1004).

For example, the processor 1002 may support wireless communication at the device 1000 in accordance with examples as disclosed herein. The processor 1002 may be configured to operable to support a means for determining a TCI state pool.

The processor 1002 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1002 may be configured to operate a memory array using a memory controller. In some other implementations, a memory controller may be integrated into the processor 1002. The processor 1002 may be configured to execute computer-readable instructions stored in a memory (e.g., the memory 1004) to cause the device 1000 to perform various functions of the present disclosure.

The memory 1004 may include random access memory (RAM) and read-only memory (ROM). The memory 1004 may store computer-readable, computer-executable code including instructions that, when executed by the processor 1002 cause the device 1000 to perform various functions described herein. The code may be stored in a non-transitory computer-readable medium such as system memory or another type of memory. In some implementations, the code may not be directly executable by the processor 1002 but may cause a computer (e.g., when compiled and executed) to perform functions described herein. In some implementations, the memory 1004 may include, among other things, a basic I/O system (BIOS) which may control basic hardware or software operation such as the interaction with peripheral components or devices.

The I/O controller 1008 may manage input and output signals for the device 1000. The I/O controller 1008 may also manage peripherals not integrated into the device M02. In some implementations, the I/O controller 1008 may represent a physical connection or port to an external peripheral. In some implementations, the I/O controller 1008 may utilize an operating system such as iOS®, ANDROID®, MS-WINDOWS®, OS/2®, UNIX®, LINUX®, or another known operating system. In some implementations, the I/O controller 1008 may be implemented as part of a processor, such as the processor 1006. In some implementations, a user may interact with the device 1000 via the I/O controller 1008 or via hardware components controlled by the I/O controller 1008.

In some implementations, the device 1000 may include a single antenna 1010. However, in some other implementations, the device 1000 may have more than one antenna 1010 (i.e., multiple antennas), including multiple antenna panels or antenna arrays, which may be capable of concurrently transmitting or receiving multiple wireless transmissions. The transceiver 1006 may communicate bi-directionally, via the one or more antennas 1010, wired, or wireless links as described herein. For example, the transceiver 1006 may represent a wireless transceiver and may communicate bi-directionally with another wireless transceiver. The transceiver 1006 may also include a modem to modulate the packets, to provide the modulated packets to one or more antennas 1010 for transmission, and to demodulate packets received from the one or more antennas 1010. The transceiver 1006 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 1010 for transmitting the amplified signal into the air or wireless medium.

A receive chain may be configured to receive signals (e.g., control information, data, packets) over a wireless medium. For example, the receive chain may include one or more antennas 1010 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

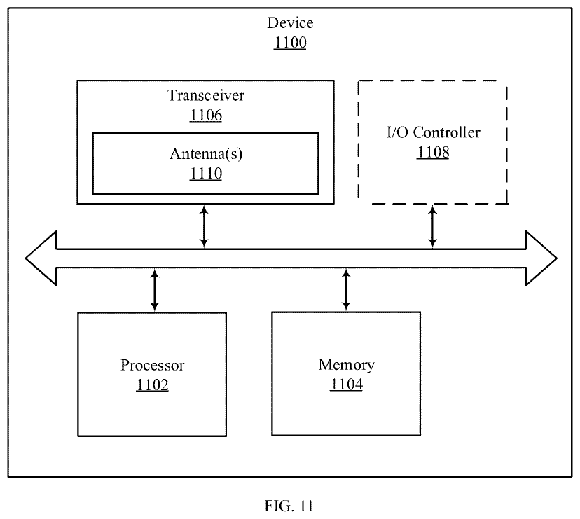

FIG. 11 illustrates an example of a device 1100 that supports the solution for determining a TCI state pool in accordance with aspects of the present disclosure. The device 1100 may be an example of a UE 104 as described herein. The device 1100 may support wireless communication with one or more network entities 102, UEs 104, or any combination thereof. The device 1100 may include components for bi-directional communications including components for transmitting and receiving communications, such as a processor 1102, a memory 1104, a transceiver 1106, and, optionally, an I/O controller 1108. These components may be in electronic communication or otherwise coupled (e.g., operatively, communicatively, functionally, electronically, electrically) via one or more interfaces (e.g., buses).

The processor 1102, the memory 1104, the transceiver 1106, or various combinations thereof or various components thereof may be examples of means for performing various aspects of the present disclosure as described herein. For example, the processor 1102, the memory 1104, the transceiver 1106, or various combinations or components thereof may support a method for performing one or more of the operations described herein.

In some implementations, the processor 1102, the memory 1104, the transceiver 1106, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1102 and the memory 1104 coupled with the processor 1102 may be configured to perform one or more of the functions described herein (e.g., executing, by the processor 1102, instructions stored in the memory 1104).

For example, the processor 1102 may support wireless communication at the device 1100 in accordance with examples as disclosed herein. The processor 1102 may be configured to operable to support a means for determining a TCI state pool.

The processor 1102 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1102 may be configured to operate a memory array using a memory controller. In some other implementations, a memory controller may be integrated into the processor 1102. The processor 1102 may be configured to execute computer-readable instructions stored in a memory (e.g., the memory 1104) to cause the device 1100 to perform various functions of the present disclosure.

The memory 1104 may include random access memory (RAM) and read-only memory (ROM). The memory 1104 may store computer-readable, computer-executable code including instructions that, when executed by the processor 1102 cause the device 1100 to perform various functions described herein. The code may be stored in a non-transitory computer-readable medium such as system memory or another type of memory. In some implementations, the code may not be directly executable by the processor 1102 but may cause a computer (e.g., when compiled and executed) to perform functions described herein. In some implementations, the memory 1104 may include, among other things, a basic I/O system (BIOS) which may control basic hardware or software operation such as the interaction with peripheral components or devices.

The I/O controller 1108 may manage input and output signals for the device 1100. The I/O controller 1108 may also manage peripherals not integrated into the device M02. In some implementations, the I/O controller 1108 may represent a physical connection or port to an external peripheral. In some implementations, the I/O controller 1108 may utilize an operating system such as iOS®, ANDROID®, MS-WINDOWS®, OS/2®, UNIX®, LINUX®, or another known operating system. In some implementations, the I/O controller 1108 may be implemented as part of a processor, such as the processor 1106. In some implementations, a user may interact with the device 1100 via the I/O controller 1108 or via hardware components controlled by the I/O controller 1108.

In some implementations, the device 1100 may include a single antenna 1110. However, in some other implementations, the device 1100 may have more than one antenna 1110 (i.e., multiple antennas), including multiple antenna panels or antenna arrays, which may be capable of concurrently transmitting or receiving multiple wireless transmissions. The transceiver 1106 may communicate bi-directionally, via the one or more antennas 1110, wired, or wireless links as described herein. For example, the transceiver 1106 may represent a wireless transceiver and may communicate bi-directionally with another wireless transceiver. The transceiver 1106 may also include a modem to modulate the packets, to provide the modulated packets to one or more antennas 1110 for transmission, and to demodulate packets received from the one or more antennas 1110. The transceiver 1106 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 1110 for transmitting the amplified signal into the air or wireless medium.

A receive chain may be configured to receive signals (e.g., control information, data, packets) over a wireless medium. For example, the receive chain may include one or more antennas 1110 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

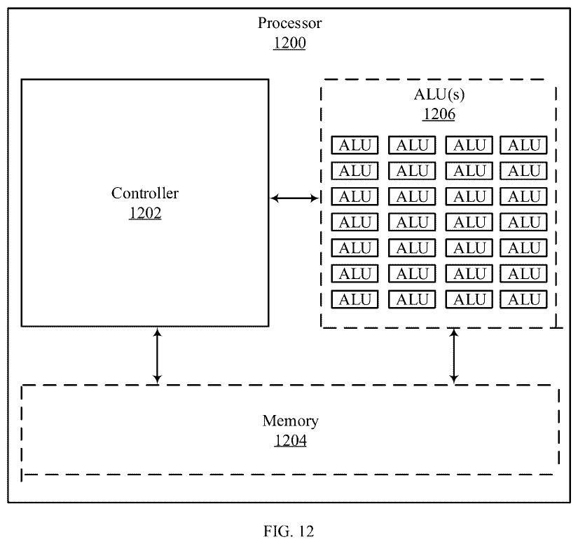

FIG. 12 illustrates an example of a processor 1200 that supports determining a TCI state pool in accordance with aspects of the present disclosure. The processor 1200 may be an example of a processor configured to perform various operations in accordance with examples as described herein. The processor 1200 may include a controller 1202 configured to perform various operations in accordance with examples as described herein. The processor 1200 may optionally include at least one memory 1204, such as L1/L2/L3 cache. Additionally, or alternatively, the processor 1200 may optionally include one or more arithmetic-logic units (ALUs) 1200. One or more of these components may be in electronic communication or otherwise coupled (e.g., operatively, communicatively, functionally, electronically, electrically) via one or more interfaces (e.g., buses).

The processor 1200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1202 may be configured to manage and coordinate various operations (e.g., signaling, receiving, obtaining, retrieving, transmitting, outputting, forwarding, storing, determining, identifying, accessing, writing, reading) of the processor 1200 to cause the processor 1200 to support various operations of a base station in accordance with examples as described herein. For example, the controller 1202 may operate as a control unit of the processor 1200, generating control signals that manage the operation of various components of the processor 1200. These control signals include enabling or disabling functional units, selecting data paths, initiating memory access, and coordinating timing of operations.

The controller 1202 may be configured to fetch (e.g., obtain, retrieve, receive) instructions from the memory 1204 and determine subsequent instruction(s) to be executed to cause the processor 1200 to support various operations in accordance with examples as described herein. The controller 1202 may be configured to track memory address of instructions associated with the memory 1204. The controller 1202 may be configured to decode instructions to determine the operation to be performed and the operands involved. For example, the controller 1202 may be configured to interpret the instruction and determine control signals to be output to other components of the processor 1200 to cause the processor 1200 to support various operations in accordance with examples as described herein. Additionally, or alternatively, the controller 1202 may be configured to manage flow of data within the processor 1200. The controller 1202 may be configured to control transfer of data between registers, arithmetic logic units (ALUs), and other functional units of the processor 1200.

The memory 1204 may include one or more caches (e.g., memory local to or included in the processor 1200 or other memory, such RAM, ROM, DRAM, SDRAM, SRAM, MRAM, flash memory, etc. In some implementation, the memory 1204 may reside within or on a processor chipset (e.g., local to the processor 1200). In some other implementations, the memory 1204 may reside external to the processor chipset (e.g., remote to the processor 1200).

The memory 1204 may store computer-readable, computer-executable code including instructions that, when executed by the processor 1200, cause the processor 1200 to perform various functions described herein. The code may be stored in a non-transitory computer-readable medium such as system memory or another type of memory. The controller 1202 and/or the processor 1200 may be configured to execute computer-readable instructions stored in the memory 1204 to cause the processor 1200 to perform various functions. For example, the processor 1200 and/or the controller 1202 may be coupled with or to the memory 1204, and the processor 1200, the controller 1202, and the memory 1204 may be configured to perform various functions described herein. In some examples, the processor 1200 may include multiple processors and the memory 1204 may include multiple memories. One or more of the multiple processors may be coupled with one or more of the multiple memories, which may, individually or collectively, be configured to perform various functions herein.

The one or more ALUs 1200 may be configured to support various operations in accordance with examples as described herein. In some implementation, the one or more ALUs 1200 may reside within or on a processor chipset (e.g., the processor 1200). In some other implementations, the one or more ALUs 1200 may reside external to the processor chipset (e.g., the processor 1200). One or more ALUs 1200 may perform one or more computations such as addition, subtraction, multiplication, and division on data. For example, one or more ALUs 1200 may receive input operands and an operation code, which determines an operation to be executed. One or more ALUs 1200 be configured with a variety of logical and arithmetic circuits, including adders, subtractors, shifters, and logic gates, to process and manipulate the data according to the operation. Additionally, or alternatively, the one or more ALUs 1200 may support logical operations such as AND, OR, exclusive-OR (XOR), not-OR (NOR), and not-AND (NAND), enabling the one or more ALUs 1200 to handle conditional operations, comparisons, and bitwise operations.

The processor 1200 may support wireless communication in accordance with examples as disclosed herein. The processor 1200 may be configured to or operable to support a means for determining a transmission configuration indicator state pool.

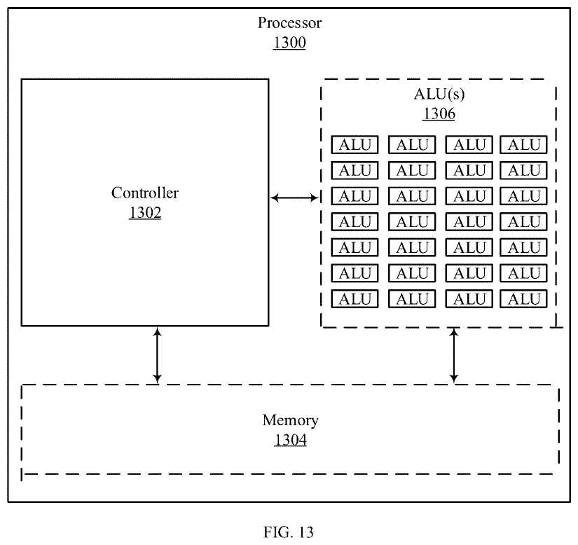

FIG. 13 illustrates an example of a processor 1300 that supports determining a TCI state pool in accordance with aspects of the present disclosure. The processor 1300 may be an example of a processor configured to perform various operations in accordance with examples as described herein. The processor 1300 may include a controller 1302 configured to perform various operations in accordance with examples as described herein. The processor 1300 may optionally include at least one memory 1304, such as L1/L2/L3 cache. Additionally, or alternatively, the processor 1300 may optionally include one or more arithmetic-logic units (ALUs) 1300. One or more of these components may be in electronic communication or otherwise coupled (e.g., operatively, communicatively, functionally, electronically, electrically) via one or more interfaces (e.g., buses).

The processor 1300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1302 may be configured to manage and coordinate various operations (e.g., signaling, receiving, obtaining, retrieving, transmitting, outputting, forwarding, storing, determining, identifying, accessing, writing, reading) of the processor 1300 to cause the processor 1300 to support various operations of a UE in accordance with examples as described herein. For example, the controller 1302 may operate as a control unit of the processor 1300, generating control signals that manage the operation of various components of the processor 1300. These control signals include enabling or disabling functional units, selecting data paths, initiating memory access, and coordinating timing of operations.

The controller 1302 may be configured to fetch (e.g., obtain, retrieve, receive) instructions from the memory 1304 and determine subsequent instruction(s) to be executed to cause the processor 1300 to support various operations in accordance with examples as described herein. The controller 1302 may be configured to track memory address of instructions associated with the memory 1304. The controller 1302 may be configured to decode instructions to determine the operation to be performed and the operands involved. For example, the controller 1302 may be configured to interpret the instruction and determine control signals to be output to other components of the processor 1300 to cause the processor 1300 to support various operations in accordance with examples as described herein. Additionally, or alternatively, the controller 1302 may be configured to manage flow of data within the processor 1300. The controller 1302 may be configured to control transfer of data between registers, arithmetic logic units (ALUs), and other functional units of the processor 1300.

The memory 1304 may include one or more caches (e.g., memory local to or included in the processor 1300 or other memory, such RAM, ROM, DRAM, SDRAM, SRAM, MRAM, flash memory, etc. In some implementation, the memory 1304 may reside within or on a processor chipset (e.g., local to the processor 1300). In some other implementations, the memory 1304 may reside external to the processor chipset (e.g., remote to the processor 1300).

The memory 1304 may store computer-readable, computer-executable code including instructions that, when executed by the processor 1300, cause the processor 1300 to perform various functions described herein. The code may be stored in a non-transitory computer-readable medium such as system memory or another type of memory. The controller 1302 and/or the processor 1300 may be configured to execute computer-readable instructions stored in the memory 1304 to cause the processor 1300 to perform various functions. For example, the processor 1300 and/or the controller 1202 may be coupled with or to the memory 1304, and the processor 1300, the controller 1302, and the memory 1304 may be configured to perform various functions described herein. In some examples, the processor 1300 may include multiple processors and the memory 1304 may include multiple memories. One or more of the multiple processors may be coupled with one or more of the multiple memories, which may, individually or collectively, be configured to perform various functions herein.

The one or more ALUs 1300 may be configured to support various operations in accordance with examples as described herein. In some implementation, the one or more ALUs 1300 may reside within or on a processor chipset (e.g., the processor 1300). In some other implementations, the one or more ALUs 1300 may reside external to the processor chipset (e.g., the processor 1300). One or more ALUs 1300 may perform one or more computations such as addition, subtraction, multiplication, and division on data. For example, one or more ALUs 1300 may receive input operands and an operation code, which determines an operation to be executed. One or more ALUs 1300 be configured with a variety of logical and arithmetic circuits, including adders, subtractors, shifters, and logic gates, to process and manipulate the data according to the operation. Additionally, or alternatively, the one or more ALUs 1300 may support logical operations such as AND, OR, exclusive-OR (XOR), not-OR (NOR), and not-AND (NAND), enabling the one or more ALUs 1300 to handle conditional operations, comparisons, and bitwise operations.

The processor 1300 may support wireless communication in accordance with examples as disclosed herein. The processor 1300 may be configured to or operable to support a means for determining a transmission configuration indicator state pool.

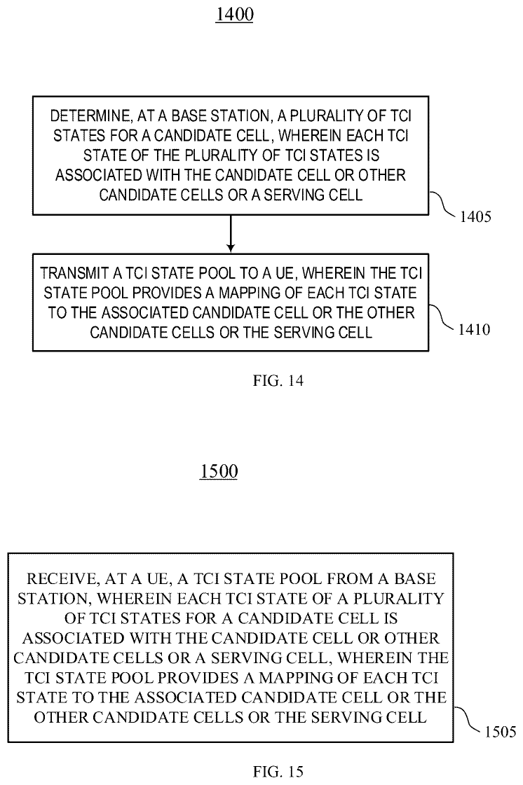

FIG. 14 illustrates a flowchart of a method 1400 that supports determining a TCI state pool in accordance with aspects of the present disclosure. The operations of the method 1400 may be implemented by a device or its components as described herein. For example, the operations of the method 1400 may be performed by a network entity 102 as described herein. In some implementations, the device may execute a set of instructions to control the function elements of the device to perform the described functions. Additionally, or alternatively, the device may perform aspects of the described functions using special-purpose hardware.

At 1405, the method may include determining a plurality of TCI states for a candidate cell, wherein each TCI state of the plurality of TCI states is associated with the candidate cell or other candidate cells or a serving cell. The operations of 1405 may be performed in accordance with examples as described herein. In some implementations, aspects of the operations of 1405 may be performed by a device as described with reference to FIG. 1A.

At 1410, the method may include transmitting a TCI state pool to a UE, wherein the TCI state pool provides a mapping of each TCI state to the associated candidate cell or the other candidate cells or the serving cell. The operations of 1410 may be performed in accordance with examples as described herein. In some implementations, aspects of the operations of 1410 may be performed by a device as described with reference to FIG. 1A.

FIG. 15 illustrates a flowchart of a method 1500 that supports determining a TCI state pool in accordance with aspects of the present disclosure. The operations of the method 1500 may be implemented by a device or its components as described herein. For example, the operations of the method 1500 may be performed by a UE 104 as described herein. In some implementations, the device may execute a set of instructions to control the function elements of the device to perform the described functions. Additionally, or alternatively, the device may perform aspects of the described functions using special-purpose hardware.

At 1505, the method may include receiving a TCI state pool from a base station, wherein each TCI state of a plurality of TCI states for a candidate cell is associated with the candidate cell or other candidate cells or a serving cell, wherein the TCI state pool provides a mapping of each TCI state to the associated candidate cell or the other candidate cells or the serving cell. The operations of 1505 may be performed in accordance with examples as described herein. In some implementations, aspects of the operations of 1505 may be performed by a device as described with reference to FIG. 1A.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

In summary, embodiments of the present disclosure may provide the following solutions.

Clause 1. A base station comprising:
a processor; and
a transceiver coupled to the processor,
wherein the processor is configured to:
   determine a plurality of transmission configuration indicator (TCI) states for a candidate cell, wherein each TCI state of the plurality of TCI states is associated with the candidate cell or other candidate cells or a serving cell; and
   transmit, via the transceiver, a TCI state pool to a user equipment (UE), wherein the TCI state pool provides a mapping of each TCI state to the associated candidate cell or the other candidate cells or the serving cell.

Clause 2. The base station of clause 1, wherein the processor is further configured to:
transmit, via the transceiver, an indicator indicating whether the TCI state pool is to be used when the UE moves to the candidate cell.

Clause 3. The base station of clause 1, wherein the base station includes a central unit (CU), a source distributed unit (DU) serving the UE, and one or more candidate DUs.

Clause 4. The base station of clause 3, wherein the CU is configured to transmit the TCI state pool to the source DU.

Clause 5. The base station of clause 3, wherein the CU is configured to transmit the TCI state pool to the one or more candidate DUs.

Clause 6. The base station of clause 3, wherein the CU is configured to transmit, to the UE, an enquiry for TCI state capability for performing a layer 1 (L1)/layer 2 (L2) triggered mobility (LTM); and
in response to transmitting the enquiry for TCI state capability, the CU is configured to receive, from the UE, the TCI state capability.

Clause 7. The base station of clause 6, wherein the enquiry for the TCI state capability further comprises a filter indicative of information by which the CU requests the UE to filter the TCI state capability.

Clause 8. The base station of clause 6, wherein the TCI state capability comprises one of the following:
a TCI state type, wherein the TCI state type indicates a type of TCI state activation that the UE supports for the LTM; or
a maximum number of TCI states that the UE supports for a group of candidate cells, or for each candidate cell in the group of candidate cells, or for a group of serving cell and candidate cells.

Clause 9. The base station of clause 7, wherein the filter comprises one of the following:
a TCI state type, wherein the TCI state type indicates a type of TCI state activation that the UE supports for the LTM; or
a maximum number of TCI states that the UE supports for a group of candidate cells, or for each candidate cell in the group of candidate cells, or for a group of serving cell and candidate cells.

Clause 10. The base station of clause 6, wherein the CU is configured to determine a number of TCI states associated with the candidate cell based on the TCI state capability; or the CU is configured to determine a maximum number of TCI states associated with the candidate cell based on the TCI state capability.

Clause 11. The base station of clause 3, wherein the CU is configured to transmit, to one of the candidate DUs, a first message comprising a plurality of TCI states associated with the other candidate cells, and/or a plurality of TCI states associated with a serving cell.

Clause 12. The base station of clause 3, wherein the CU is configured to transmit, to the or each candidate DU, the number of TCI states associated with the or each candidate cell and/or the maximum number of TCI states associated with the or each candidate cell.

Clause 13. The base station of any of clauses 1-12, wherein the TCI state pool is a first TCI state pool, and:
the or each candidate DU is configured to determine the first TCI state pool, wherein the first TCI state pool is for the candidate cell, wherein the first TCI state pool includes a plurality of TCI states associated with the candidate cell and/or a plurality of TCI states associated with the other one or more candidate cells, and/or a plurality of TCI states associated with a serving cell; and
the candidate DU is configured to transmit the first TCI state pool to the CU.

Clause 14. The base station of clause 13, wherein the or each candidate DU is configured to determine a first TCI state group to be activated; and
the candidate DU is configured to transmit, to the CU, the first TCI state group via the second message.

Clause 15. The base station of clause 3, wherein the CU is configured to transmit, to the source DU, a third message comprising a plurality of TCI states associated with the or each candidate cell, and/or a plurality of TCI states associated with the other candidate cells.

Clause 16. The base station of clause 3, wherein the CU is configured to transmit, to the source DU, the number of TCI states associated with the or each candidate cell and/or the maximum number of TCI states associated with the candidate cell.

Clause 17. The base station of any of clauses 1-16, wherein the TCI state pool is a second TCI state pool, and:
the source DU is configured to determine the second TCI state pool, wherein the second TCI state pool is for the serving cell, wherein the second TCI state pool includes a plurality of TCI states associated with the serving cell, and/or a plurality of TCI states associated with the or each candidate cell, and/or a plurality of TCI states associated with the other candidate cells; and
the source DU is configured to transmit the second TCI state pool to the CU.

Clause 18. The base station of clause 17, wherein the source DU is configured to determine a second TCI state group to be activated; and the source DU is configured to transmit, to the CU, the second TCI state group via the fourth message.

Clause 19. The base station of clause 3, wherein the CU is configured to receive a plurality of TCI states associated with the or each candidate cell from the candidate DU, and/or a plurality of TCI states associated with the one or more other candidate cells from the one or more other candidate DUs.

Clause 20. The base station of clause 3, wherein the TCI state pool is a fourth TCI state pool, and:
the CU is configured to determine the fourth TCI state pool is for the serving cell, wherein the fourth TCI state pool includes a plurality of TCI states associated with the serving cell, and/or a plurality of TCI states associated with the or each candidate cell, and/or a plurality of TCI states associated with the other candidate cells.

Clause 21. The base station of clause 3, wherein the TCI state pool is a fifth TCI state pool, and:
the CU is configured to determine the fifth TCI state pool is for the or each candidate cell, wherein the fifth TCI state pool includes a plurality of TCI states associated with the candidate cell, and/or a plurality of TCI states associated with the one or more other candidate cells, and/or a plurality of TCI states associated with the serving cell.

Clause 22. The base station of clause 3, wherein the TCI state pool is a sixth TCI state pool, and:
the source DU is configured to determine the sixth TCI state pool, wherein the sixth TCI state pool is for the serving cell, wherein the sixth TCI state pool includes a plurality of TCI states associated with the serving cell, and/or a plurality of TCI states associated with the or each candidate cell, and/or a plurality of TCI states associated with the one or more other candidate cells; and
the source DU is configured to transmit, to the CU, the sixth TCI state pool.

Clause 23. The base station of clause 3, wherein the TCI state pool is a seventh TCI state pool, and:
the source DU is configured to determine the seventh TCI state pool, wherein the seventh TCI state pool is for the candidate cell, wherein the seventh TCI state pool includes a plurality of TCI states associated with the or each candidate cell, and/or a plurality of TCI states associated with the one or more other candidate cells, and/or a plurality of TCI states associated with the serving cell; and
the source DU is configured to transmit, to the CU, the seventh TCI state pool.

Clause 24. The base station of clause 3, wherein the source DU is configured to receive a plurality of TCI states associated with the or each candidate cell from the CU, and/or a plurality of TCI states associated with the one or more other candidate cells from the CU.

Clause 25. The base station of clause 23, wherein the CU is configured to transmit, to the candidate DU, the seventh TCI state pool.

Clause 26. The base station of clause 3, wherein the TCI state pool is an eighth TCI state pool, and:
the CU is configured to determine the eighth TCI state pool, wherein the eighth TCI state pool is for the serving cell and the candidate cell, wherein the eighth TCI state pool includes a plurality of TCI states associated with the or each candidate cell, and/or a plurality of TCI states associated with the one or more other candidate cells, and/or a plurality of TCI states associated with the serving cell.

Clause 27. The base station of clause 26, wherein the CU is configured to transmit, to the UE, the source DU and the candidate DU, a second mapping between TCI state indexes in the eighth TCI state pool and TCI state indexes in TCI state pool for the serving cell and TCI state pool for the candidate cell.

Clause 28. The base station of any of clauses 1-27, wherein the CU is configured to determine a third TCI state group to be activated, wherein the third TCI state group includes identity (ID) of the serving cell and/or IDs of the one or more candidate cells, wherein:
the third TCI state group is the same with the first TCI state group;
the third TCI state group is the same with the second TCI state group; or
the third TCI state group is different from the first TCI state group and the second TCI state group.

Clause 29. The base station of clause 28, wherein the CU is configured to transmit the third TCI state group to the UE, the source DU, and/or the candidate DU.

Clause 30. The base station of clause 3, wherein the source DU is configured to transmit, to the UE, a command to activate one or more selected TCI states.

Clause 31. The base station of clause 30, wherein the command is a medium access control (MAC) control element (CE) and comprises one of the following:
an ID of the serving cell; or
an ID of the candidate cell; or
an ID of the third TCI state group.

Clause 32. The base station of clause 31, wherein the IDs of the serving cell and the one or more candidate cells is one of the following:
a physical cell identity (PCI);
a candidate cell configuration index; or
a cell global identity (CGI).

Clause 33. A user equipment (UE), comprising:
a processor; and
a transceiver coupled to the processor,
wherein the processor is configured to:
   receive, via the transceiver, a transmission configuration indicator (TCI) state pool from a base station, wherein each TCI state of a plurality of TCI states for a candidate cell is associated with the candidate cell or other candidate cells or a serving cell, wherein the TCI state pool provides a mapping of each TCI state to the associated candidate cell or the other candidate cells or the serving cell.

Clause 34. The UE of clause 33, wherein the processor is further configured to:
receive, via the transceiver, an indicator indicative of whether the TCI state pool is to be used when the UE moves to the candidate cell.

Clause 35. The UE of clause 33, wherein the processor is further configured to:
receive, via the transceiver from a source DU comprised in the base station, a command to activate one or more selected TCI states.

Clause 36. The UE of clause 35, wherein in the case that the command includes an identifier of the serving cell, the UE activates one or more corresponding TCI states based on one or more TCI state indexes.

Clause 37. The UE of clause 36, wherein in the case that the command includes an identifier of the serving cell, and the serving cell is within a TCI state group to be activated, the command applies to all the candidate cells in the TCI state group to be activated.

Clause 38. The UE of clause 35, wherein in the case that the command includes a group ID to identify the TCI state group, the command applies to all the candidate cells in the TCI state group to be activated.

Clause 39. The UE of clause 35, wherein in the case that the command includes an identifier of the candidate cell, the UE activates one or more corresponding TCI states based on one or more TCI state indexes.

Clause 40. The UE of clause 39, wherein in the case that the command includes an identifier of the candidate cell, and the candidate cell is within a TCI state group to be activated, the command applies to all the candidate cells in the TCI state group to be activated.

Clause 41. A method performed by a base station, the method comprising:
determining a plurality of transmission configuration indicator (TCI) states for a candidate cell, wherein each TCI state of the plurality of TCI states is associated with the candidate cell or other candidate cells or a serving cell; and
transmitting a TCI state pool to a user equipment (UE), wherein the TCI state pool provides a mapping of each TCI state to the associated candidate cell or the other candidate cells or the serving cell.

Clause 42. An apparatus for wireless communication, comprising:
at least one memory; and
at least one processor coupled with the at least one memory and configured to cause the apparatus to:
   receive a transmission configuration indicator (TCI) state pool from a base station, wherein each TCI state of a plurality of TCI states for a candidate cell is associated with the candidate cell or other candidate cells or a serving cell, wherein the TCI state pool provides a mapping of each TCI state to the associated candidate cell or the other candidate cells or the serving cell.

1. A base station comprising:
at least one memory; and
at least one processor coupled with the at least one memory and operable to cause the base station to:
determine a plurality of transmission configuration indicator (TCI) states for a candidate cell, wherein each TCI state of the plurality of TCI states is associated with the candidate cell or other candidate cells or a serving cell; and
transmit a TCI state pool to a user equipment (UE), wherein the TCI state pool provides a mapping of each TCI state to the associated candidate cell or the other candidate cells or the serving cell.

2. The base station of claim 1, wherein the base station includes a central unit (CU), a source distributed unit (DU) serving the UE, and one or more candidate DUs.

3. The base station of claim 2, wherein the CU is configured to transmit the TCI state pool to the source DU.

4. The base station of claim 2, wherein the CU is configured to transmit the TCI state pool to the one or more candidate DUs.

5. The base station of claim 2, wherein the CU is configured to transmit, to one of the candidate DUs, a message comprising a plurality of TCI states associated with one or more of the other candidate cells, or the plurality of TCI states associated with the serving cell.

6. The base station of claim 5, wherein the TCI state pool is a first TCI state pool, and wherein:
the or each candidate DU is configured to determine the first TCI state pool, wherein the first TCI state pool is for the candidate cell, wherein the first TCI state pool includes one or more of a plurality of TCI states associated with the candidate cell, a plurality of TCI states associated with the other one or more candidate cells, or a plurality of TCI states associated with the serving cell; and
the candidate DU is configured to transmit the first TCI state pool to the CU.

7. The base station of claim 2, wherein the CU is configured to transmit, to the source DU, a message comprising a plurality of TCI states associated with one or more of the or each candidate cell, or the plurality of TCI states associated with the other candidate cells.

8. The base station of claim 7, wherein the TCI state pool is a second TCI state pool, and wherein:
the source DU is configured to determine the second TCI state pool, wherein the second TCI state pool is for the serving cell, wherein the second TCI state pool includes one or more of a plurality of TCI states associated with the serving cell, a plurality of TCI states associated with each candidate cell, or a plurality of TCI states associated with the other candidate cells; and
the source DU is configured to transmit the second TCI state pool to the CU.

9. The base station of claim 2, wherein the CU is configured to receive a plurality of TCI states associated with one or more of the or each candidate cell from the candidate DU, or a plurality of TCI states associated with the other candidate cells from the one or more candidate DUs.

10. The base station of claim 2, wherein the TCI state pool is a second TCI state pool, and wherein:
the CU is configured to determine the second TCI state pool is for the or each candidate cell, wherein the second TCI state pool includes one or more of a plurality of TCI states associated with the candidate cell, a plurality of TCI states associated with the other candidate cells, or a plurality of TCI states associated with the serving cell.

11. The base station of claim 2, wherein the source DU is configured to receive one or more of a plurality of TCI states associated with the or each candidate cell from the CU, or a plurality of TCI states associated with the other candidate cells from the CU.

12. The base station of claim 2, wherein the at least one processor is operable to cause the source DU of the base station to transmit, to the UE, a command to activate one or more selected TCI states.

13. The base station of claim 12, wherein the command is a medium access control (MAC) control element (CE) and comprises one of:
an ID of the serving cell;
an ID of the candidate cell; or
an ID of a TCI state group.

14. The base station of claim 13, wherein the ID of the serving cell and the ID of the candidate cell is one of:
a physical cell identity (PCI);
a candidate cell configuration index; or
a cell global identity (CGI).

15. A user equipment (UE), comprising:
at least one memory; and
at least one processor coupled with the at least one memory and operable to cause the UE to:
receive, from a base station, a transmission configuration indicator (TCI) state pool, wherein each TCI state of a plurality of TCI states for a candidate cell is associated with the candidate cell or other candidate cells or a serving cell, wherein the TCI state pool provides a mapping of each TCI state to the associated candidate cell or the other candidate cells or the serving cell.

16. The UE of claim 15, wherein the at least one processor is further configured to receive, from a source DU comprised in the base station, a command to activate one or more selected TCI states.

17. The UE of claim 16, wherein the command includes an identifier of the candidate cell, and the UE activates one or more corresponding TCI states based on one or more TCI state indexes.

18. The UE of claim 17, wherein the candidate cell is within a TCI state group to be activated, and the command applies to all candidate cells in the TCI state group to be activated.

19. A method performed by a base station, the method comprising:
determining a plurality of transmission configuration indicator (TCI) states for a candidate cell, wherein each TCI state of the plurality of TCI states is associated with the candidate cell or other candidate cells or a serving cell; and
transmitting a TCI state pool to a user equipment (UE), wherein the TCI state pool provides a mapping of each TCI state to the associated candidate cell or the other candidate cells or the serving cell.

20. A method performed by a user equipment (UE), the method comprising:
receiving, from a base station, a transmission configuration indicator (TCI) state pool, wherein each TCI state of a plurality of TCI states for a candidate cell is associated with the candidate cell or other candidate cells or a serving cell, wherein the TCI state pool provides a mapping of each TCI state to the associated candidate cell or the other candidate cells or the serving cell.
